(19) United States
(12) Patent Application Publication
(10) Pub. No.: US 2026/0105334 A1
(43) Pub. Date: Apr. 16, 2026

(54) DECODING DYNAMICAL SYSTEMS

(71) Applicant: The University of Chicago, Chicago, IL (US)

(72) Inventors: Matthew Kaufman, Chicago, IL (US); David A. Sabatini, Chicago, IL (US)

(21) Appl. No.: 19/409,444

(22) Filed: Dec. 4, 2025

Related U.S. Application Data
(63) Continuation of application No. PCT/US2024/032822, filed on Jun. 6, 2024.
(60) Provisional application No. 63/506,500, filed on Jun. 6, 2023.

(51) Int. Cl. G06N 7/01; G06F 3/01; G06F 18/2137

(52) U.S. Cl. CPC G06N 7/01; G06F 3/015; G06F 18/21375

(57) ABSTRACT

Methods and systems for state decoding from a signal are provided, including decoding signals using parametrization of dynamical systems. Certain embodiments enable reading a collection of neural signals over a period of time from a brain-machine interface.

### RELATED APPLICATION(S)

This application is a continuation of PCT Application No. PCT/US2024/032822, filed Jun. 6, 2024, which claims the benefit of U.S. Provisional App. No. 63/506,500, filed Jun. 6, 2023, each of which is incorporated herein by reference in its entirety.

### GOVERNMENT RIGHTS

This invention was made with government support under NS125270 awarded by the National Institutes of Health. The government has certain rights in the invention.

### TECHNICAL FIELD

The invention relates generally to methods of state decoding from a signal, and, in particular, to systems and methods for decoding signals using parametrization of dynamical systems. Exemplary embodiments decode brain signals from a brain-machine interface system.

### BACKGROUND

Almost all decoding problems can be described in a common manner: some system comprises a set of latent variables that interact and change over time. These latent variables are called the “state” of the system, and can be thought of as a point in a “state space.” Embodiments of the present disclosure include systems with “dynamics,” so that the system's state changes over time in a lawful manner. These systems produce some output, which is also a function of the state. This output cannot be accessed in real time, and must be predicted moment-by-moment. If the state was accessible and the output function was known, this performance could be trivially performed-however, the state is not accessible. Instead, only imperfect, noisy, and perhaps indirect measurements of the system's state can be taken. These noisy measurements can be turned into predictions about the system's state, which are translated into predictions about the system's output.

The approaches provided herein are applicable to many problems throughout science and engineering, including problems in robotics, aerospace, finance market prediction, user interfaces, and Brain-Machine Interfaces (BMIs). Several examples herein focus on the domain of BMIs. BMIs are systems that use signals from the brain to control a computer, robotic arm, or other device. At the core of BMIs are algorithms (“decoders”) that translate signals from the brain into control signals that are used to control an external device (“decoding”). It has long been known that the firing rates of neurons in motor areas (the “population state”) collectively encode movements of the arm and hand. Using recorded neural activity for decoders is challenging, however, because only a modest number of the neurons in the brain at one time can be recorded and because these signals are intrinsically noisy. Recent work has shown that neural populations act like a “dynamical system”: the current population state strongly predicts the population state a few moments later. Prior decoding algorithms have leveraged only the instantaneous relationship between neural activity and movement.

Accordingly, there is a need to greatly improve decoding quality of dynamical systems with methods that require less training data. This challenging example is discussed herein to demonstrate the invention.

### SUMMARY

In various embodiments, methods for decoding dynamical systems are provided. A collection of signals over a period of time is read. The collection of signals is interpolated to form a signal manifold. A gridded manifold is constructed in parameter state space, where one parameter is time. A state is inferred as a position on the gridded manifold based on the collection of signals. A probability distribution of the state is propagated over the gridded manifold. Based on the probability distribution of the state, one or more output is predicted.

In some embodiments, the collection of signals comprises neural signals and the state progression corresponds to progress through a movement.

In some embodiments, the collection of signals is read from a brain-machine interface.

In some embodiments, a time series of control signals is determined for an effector based on the predicted one or more output.

In some embodiments, a desired output signal is received, associated with the collection of signals, as training data.

In some embodiments, the gridded manifold comprises a parametrized continuous set of signals over time.

In some embodiments, the signal manifold is parametrized in a space of possible neural population states.

In some embodiments, the inferred position is based on a collection of signals of neurons.

In some embodiments, controlling the effector comprises instructing a computer and/or a robot to move.

In some embodiments, propagating the probability distribution over time uses Bayesian Recursive Estimation.

In some embodiments, inferring comprises: moving the probability distribution over the gridded manifold forward one step in time; convolving an uncertainty estimation with the probability distribution; assigning a likelihood of producing an observed spike count from an associated population state within the collection of signals to each grid point; normalizing the likelihood with the previous probability distribution to determine a maximum likelihood estimation; and outputting a stream of spike counts as a time series of control signals.

In some embodiments, inferring comprises: moving the probability distribution over the gridded manifold forward one step in time; convolving an uncertainty estimation with the probability distribution; assigning a likelihood of producing observed signals from an associated population state to each grid point; normalizing the likelihood with the previous probability distribution to determine a maximum likelihood estimation; and producing a time series of output signals.

In some embodiments, the observed signals are neural signals, and the output signals are control signals for a BMI.

In some embodiments, the gridded manifold is a discrete approximation to the manifold.

In some embodiments, the collection of signals includes signals from brain and/or motor neurons.

In some embodiments, the time dimension is circular.

In some embodiments, the collection of signals is read from a myograph and/or a brain computer interface.

In some embodiments, each point in the manifold is associated with a movement type and a relative time.

In some embodiments, the movement type includes a movement-related progression prior to the movement.

In some embodiments, the movement type includes a movement-related progression during the movement.

In some embodiments, one or more neural trajectories is identified within the manifold.

In some embodiments, the one or more neural trajectories comprise a spiking pattern in neural signaling over a threshold value.

In some embodiments, the spiking pattern is independent of a movement.

In some embodiments, the starting state of one or more neural trajectories are determined by an initial state of a neural population.

In some embodiments, the collection of signals is collected from a subject during a set of movements.

In some embodiments, the manifold is paired with an observed set of motions.

In some embodiments, the collection of signals is read from sensors on a robot.

In some embodiments, the collection of signals is read from medical testing data, such as an electrocardiogram or cardiac ultrasound.

In some embodiments, the collection of signals is read from sensors on an aircraft or spacecraft.

In some embodiments, the collection of signals is read from financial market data.

In various embodiments, a system is provided comprising an effector and a computing node configured to perform any of the foregoing methods.

In various embodiments, a computer program product comprising a non-transitory computer readable storage medium having program instructions embodied therewith is provided, the program instructions executable by a processor to cause the processor to perform any of the foregoing methods.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1A is schematic view of an exemplary pendulum system and associated dynamic output.

FIG. 1B is a set of exemplary graphs of measured, inferred, and discarded angle measurements during BMI inference as a jump in state occurs.

FIG. 1C is a set of an exemplary graphs of measured, inferred, and discarded angle measurements during BMI inference after the jump in state.

FIG. 2A is a flowchart of an exemplary method for decoding dynamical systems, in accordance with one or more embodiments of this disclosure.

FIG. 2B is a flowchart of an exemplary method for decoding brain signals within a BMI, in accordance with one or more embodiments of this disclosure.

FIG. 3A is a pair of graphs illustrating variables over time of a system and the state space in relation to those variables.

FIG. 3B is a process diagram of measuring a system with an observability barrier and outputting a graph of that reading over time, in accordance with one or more embodiments of the present disclosure.

FIG. 4A is a series of graphs illustrating a process for creating a PT-manifold, in accordance with one or more embodiments of the present disclosure.

FIG. 4B is a set of graphs illustrating a process for creating a PT-manifold, in accordance with one or more embodiments of the present disclosure.

FIG. 4C is a series of graphs illustrating a process for creating an output space, in accordance with one or more embodiments of the present disclosure.

FIG. 4D is a set of graphs illustrating an average output of an exemplary grid over a PT-manifold, in accordance with one or more embodiments of the present disclosure.

FIG. 4E is a set of graphs illustrating a process for creating a PT-manifold based on a system's state outputs, in accordance with one or more embodiments of the present disclosure.

FIG. 5A is an exemplary illustration of a macaque's motion in a reaching task.

FIG. 5B is a reach time and angle measurement for an exemplary macaque reaching motion.

FIG. 5C is a series of neural measurements resulting from an exemplary macaque reaching motion, in accordance with one or more embodiments of the present disclosure.

FIG. 5D is a series of firing rates for a neuron averaged across repeated trials, in accordance with one or more embodiments of the present disclosure.

FIG. 5E is a series of interpolations from a PT-manifold grid, in accordance with one or more embodiments of the present disclosure.

FIG. 6A is a series of graphs illustrating decoding of reach movements with a variety of methods, in accordance with one or more embodiments of the present disclosure.

FIG. 6B is a set of graphs illustrating performance differences between Kalman filters and GrID-MaPT, in accordance with one or more embodiments of the present disclosure.

FIG. 6C is a set of graphs measuring decoded reach angle as a function of reach time, in accordance with one or more embodiments of the present disclosure.

FIG. 6D is a set of graphs measuring correlation between true and decoded reach angle over time, in accordance with one or more embodiments of the present disclosure.

FIG. 6E is a distribution over time showing a single trial of true reach time vs. decoded reach time, in accordance with one or more embodiments of the present disclosure.

FIG. 6F is a set of graphs showing the distribution of true vs. decoded reach time across all trials in the dataset, in accordance with one or more embodiments of the present disclosure.

FIG. 6G is a graph illustrating reach time vs. movement probability, in accordance with one or more embodiments of the present disclosure.

FIGS. 7A-C illustrate brain-computer interfaces allowing neural activity to control external devices.

FIGS. 8A-H illustrate smooth dynamics generating neural activity, according to embodiments disclosed herein.

FIGS. 9A-G illustrate the smooth dynamics generating neural activity, according to embodiments disclosed herein.

FIGS. 10A-E illustrate interpolation of movement types and times, according to embodiments disclosed herein.

FIG. 11 illustrates the decoder precisely decoding movement from motor cortical data.

FIG. 12 is an exemplary series of graphs showing a neural input, movement readout, and related neural analysis.

FIG. 13 is an exemplary series of transformations between a neural activity manifold encoding and decoding and related neural analysis.

FIG. 14 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

Decoding issues are a very general problem, with applications across scientific and engineering disciplines. The system may be a solution undergoing a chemical reaction, the output the formation rate of a particular chemical, and the measurements various properties of the solution that are easily quantified. Alternatively, the system may be a vehicle, the output the position of the vehicle, and the measurements very noisy readings of the vehicle's position and velocity. Less traditional applications include brain-computer interfaces (BCIs, also called brain-machine interfaces, BMIs), where the system is a brain region or the user itself, the output is some time-varying action intended by the user, and the measurements are the recorded activity of some number of neurons in the user's brain.

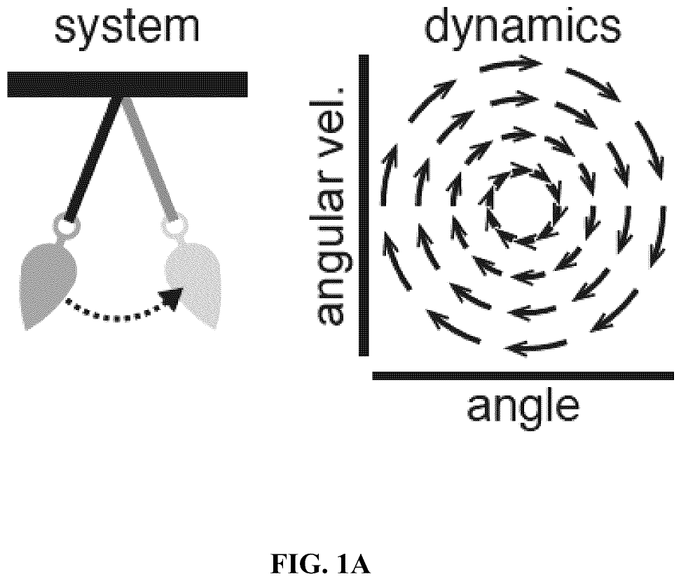

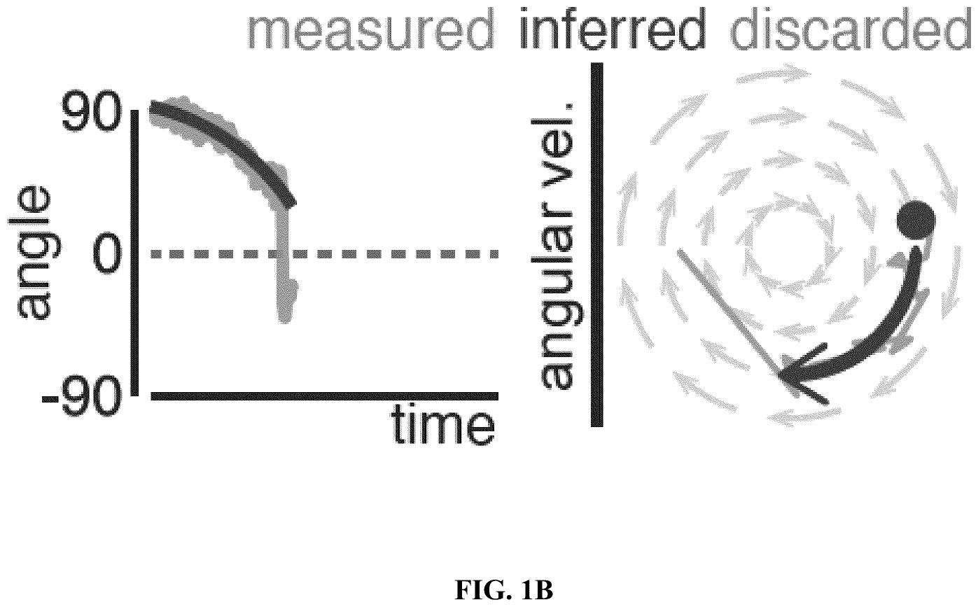

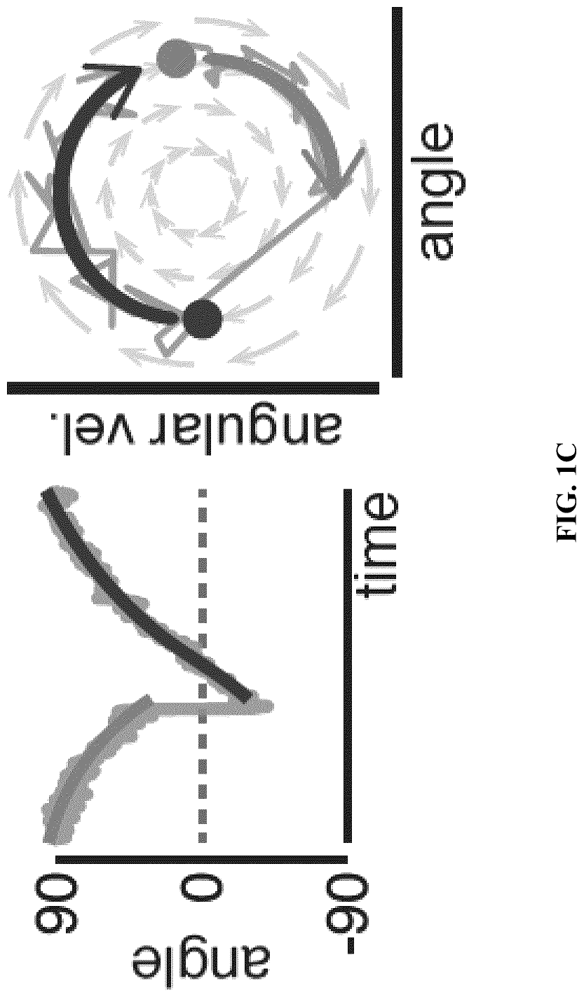

Many possible approaches have been taken to this problem. Many approaches are probabilistic: a probability distribution, changing over time as measurements come in, is used to represent the probability of the state occupying any region in state space. The probability distribution over the state then can be used to form a corresponding probability distribution over system outputs. In these approaches, the dynamics of the system can be used to help overcome measurement noise. As an example of how this works theoretically, tracking the position and velocity of a pendulum can be imagined, given only noisy measurements of the position. Suppose that after enough measurements, the pendulum is believed to be swinging downward from the left, but the next measurement suddenly indicates the pendulum has changed directions and is ascending rightwards. Due to knowledge of mechanics such as inertia, and the conviction that the pendulum is swinging downward from the left, this information is likely to be rejected as measurement noise to maintain the belief that the pendulum is swinging from the left. If this measurement is a one-off, it is correct to do so. Repeated measurements that the pendulum is ascending rightwards, however, will eventually convince the observer that the prior belief was wrong. In this manner incoming measurements and dynamics can be used to overcome measurement noise, while refining errors in our belief about the system's state. An example pendulum system is shown in FIG. 1A, with an accompanying graph of the measured angular velocity and dynamics. Further parametric measurements of the exemplary pendulum system are shown in FIGS. 1B-1C, illustrating differences in measured, inferred, and discarded information from a pendulum system.

Without further constraints, the possible relationships between observations and state are infinite, the possible dynamics a system might have are infinite, and noise may depend on state in complex ways. Practically, any real inference system must make some set of assumptions about these properties to make the problem well-formed.

Embodiments of the present disclosure include methods of estimating state variables, or those that are unable to be directly observed, and observed variables, which are measurable with noise. This allows for the estimation of state variables, and therefore also output variables, over one or more time periods. Embodiments of the present disclosure may be used in combination, for example, with brain-machine interfaces (BMIs), robotics, decoding electromyography (muscle recordings), financial time series predictions, and/or aerospace applications. In any of these examples, the system to be modeled includes an approximation of low-dimensional nonlinear dynamics and should be parametrizable.

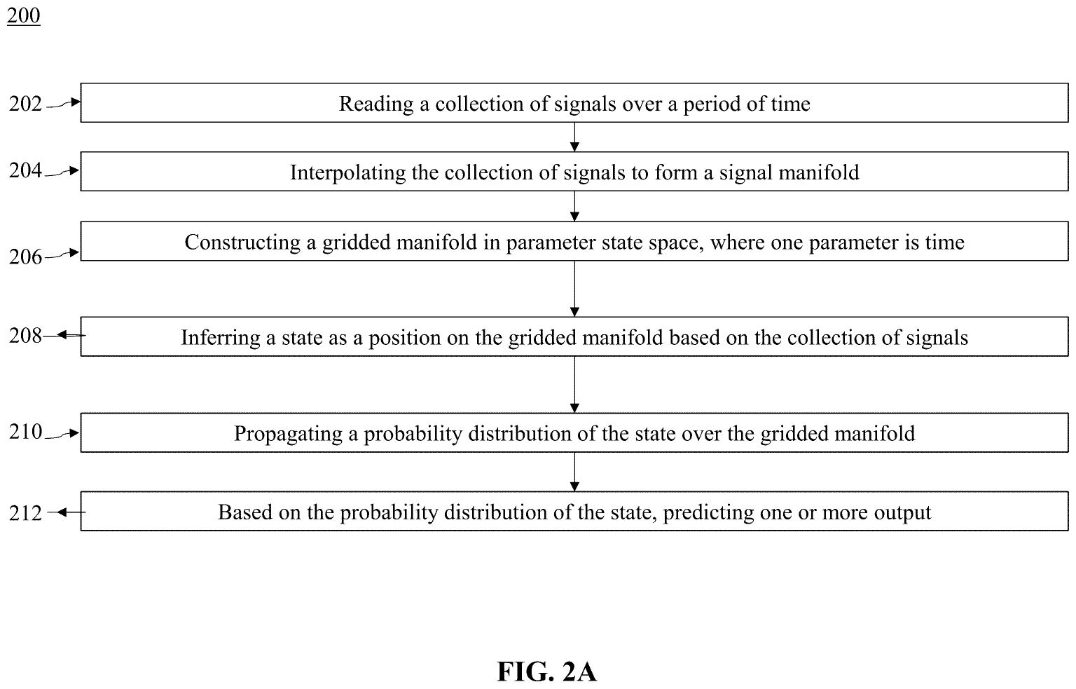

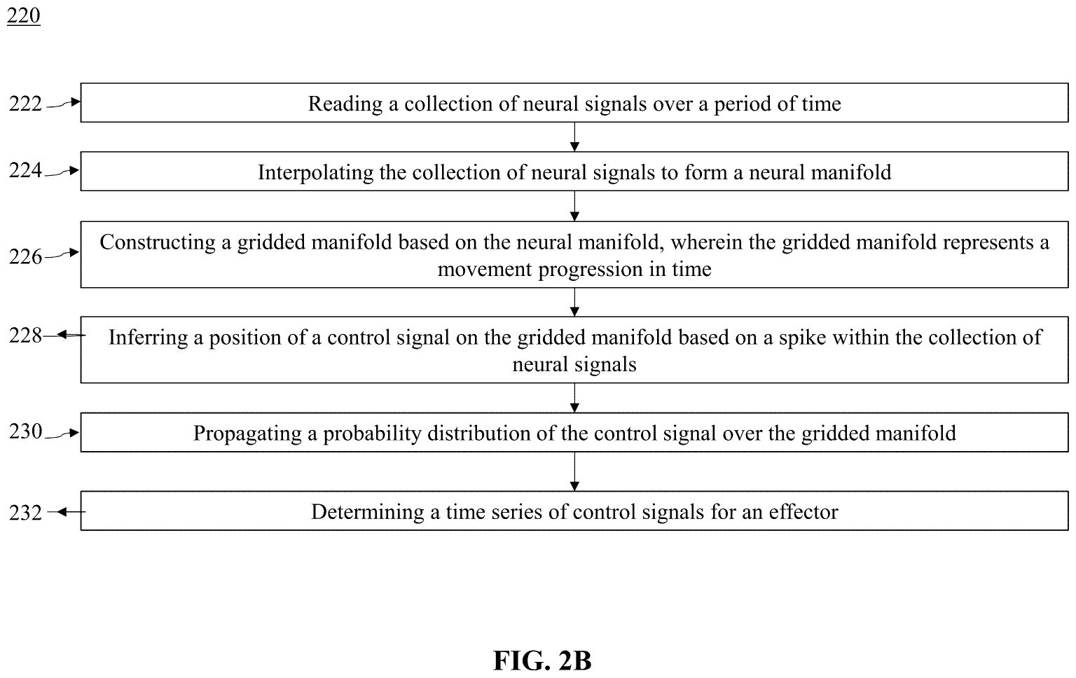

FIG. 2A is an exemplary method 200 for decoding dynamical systems. At 202, a collection of signals over a period of time is read. At 204, the collection of signals is interpolated to form a signal manifold. At 206, a gridded manifold is constructed in parameter state space, where one parameter is time. At 208, a state is inferred as a position on the gridded manifold based on the collection of signals. At 210, a probability distribution of the state is propagated over the gridded manifold. At 212, based on the probability distribution of the state, one or more output is predicted.

FIG. 2B is an exemplary method 220 for determining control signals for an effector. Method 220 (i.e., steps 222-232) can be performed by server systems based on information, images, and data received by the system over the electronic network. The method 220 can be performed automatically or in response to an input from a user. The method can be performed as discrete steps in a predetermined temporal sequence (e.g. each step completed before commencing the subsequent step), and/or in some embodiments at least some steps can partially overlap (e.g. each step need not be completed before commencing the subsequent step). In step 222, the method may include reading a collection of neural signals over a period of time. In step 224, the method may include interpolating the collection of neural signals to form a neural manifold. In step 226, the method may include constructing a gridded manifold based on the neural manifold, wherein the gridded manifold represents a movement progression in time. In step 228, the method may include inferring a position of a control signal on the gridded manifold based on a spike within the collection of neural signals. In step 230, the method includes propagating a probability distribution of the position of the control signal over the gridded manifold. In step 232, the method may include determining a time series of control signals for an effector.

### Common Approaches to Decoding

Among the most well-known version of this class of decoding method is the Kalman filter. The Kalman filter is used in a tremendous variety of different applications, such as GPS and flight control, and is a staple of state inference methods. In applications to moving objects and other linear systems, the Kalman filter is used to good effect. In other applications, however, the Kalman filter is less successful. This limited applicability is due to the assumptions the Kalman filter makes about the tracked system. The Kalman filter assumes that the system has linear dynamics, that the output is a linear function of the system's state, and that measurements of the system are linear with additive Gaussian noise. In many cases, at least one of these assumptions is not met. In such cases, the Kalman filter will fail to produce an accurate estimate of the system's output. Various methods exist to make the Kalman filter more robust to violations of these assumptions (e.g., the unscented Kalman filter), but the basic constraints remain.

Other methods make fewer assumptions about the system. Two such methods are highlighted in particular. Grid-based recursive Bayesian estimation (“grid-based inference”) discretizes the state space of the system into a fine grid. The probability of being at each point on the grid is updated over time and represents a discrete approximation to a continuous probability distribution over state space. This approach is successful in many “spatial” applications, such as when the system is the position of a vehicle, because system dynamics can just be represented as shifts on the grid. Grid-based inference, in cases where dynamics are simply represented on this grid, can be used quickly due to quantities associated with each grid-point being pre-calculated. Where system dynamics are complex, grid-based inference is harder to implement and slower for inference, as dynamics cause complex interactions with naively-chosen grids. One common technique to circumvent this challenge is to use particle filters, which use a large number of “particles” to represent a probability distribution. These particles are propagated through state space, and probabilistically replicated or terminated based on the likelihood of current measurements. Over time, the density of particles in state space tracks the probability of the state occupying that portion of state space. While quite general, particle filters require an explicit representation of the system dynamics to propagate particles, along with a parameterized function to map particle position in state space to system output. Learning these functions is typically slow and requires large amounts of data, and evaluating them for each particle can cause a substantial slow-down in inference time.

The second existing alternative approach is to infer the system's outputs using recurrent neural networks or other neural network architectures. These approaches can be powerful and have been successfully used across a variety of domains. However, these approaches to decoding have three drawbacks. The first drawback is interpretability, as neural networks are widely considered “black boxes” that cannot explain how they decode. The second drawback is that neural networks are typically quite data intensive, often requiring enormous training datasets to generalize appropriately. Finally, both training and inference with neural networks is slow. Advancements in neural network applications, however, is rapid, and it is possible that approaches such as those disclosed herein will sometimes be used in conjunction with neural networks.

### GrID-MaPT

### Overview

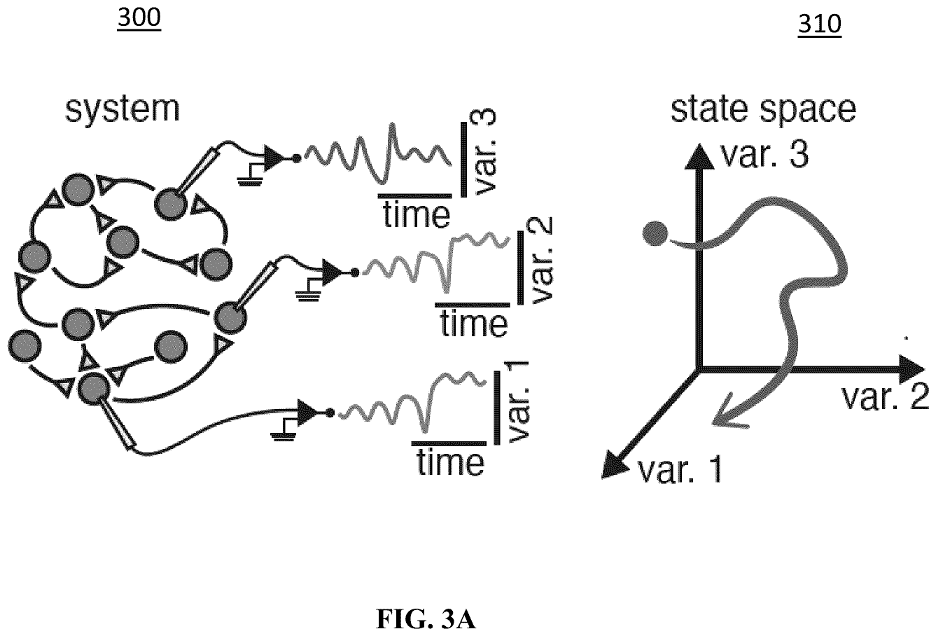

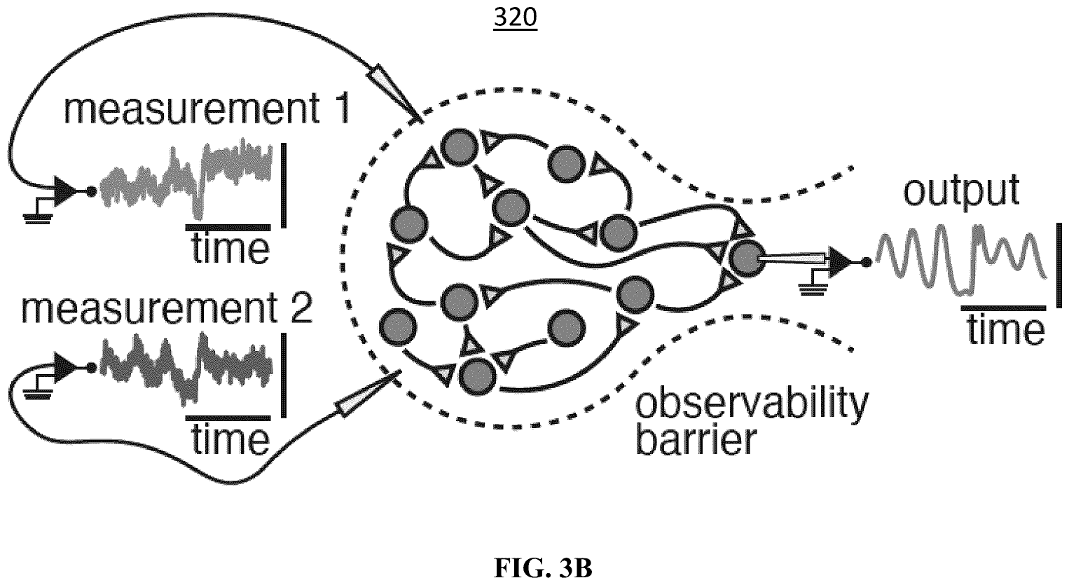

It would be advantageous to combine the generality of these state estimation methods while reducing their drawbacks. Accordingly, a representation of the system's state space in which the system's dynamics are drastically simplified is used. This representation may be called “flowbox coordinates,” “straightening a vector field,” or the “rectification theorem.” In this representation, only one coordinate changes directly in proportion to time elapsed—this coordinate is called the “system time.” The other coordinates remain static with time, termed here the “program coordinates.” Without using flowbox coordinates, the system appears more complicated. An example of using observed variables directly is shown in the graph 300 of FIG. 3A, where separate probes are shown measuring variables 1, 2, and 3 over a time. In graph 310, the state space is shown as a function of the three observed variables. An example of the challenge of inferring the system is shown in FIG. 3B, where process diagram 320 includes an observability barrier preventing the direct measurement of the system. The program-time manifold (PT-manifold) representation, in contrast, completely describes a portion of state space in a way that is adaptive to the system's dynamics.

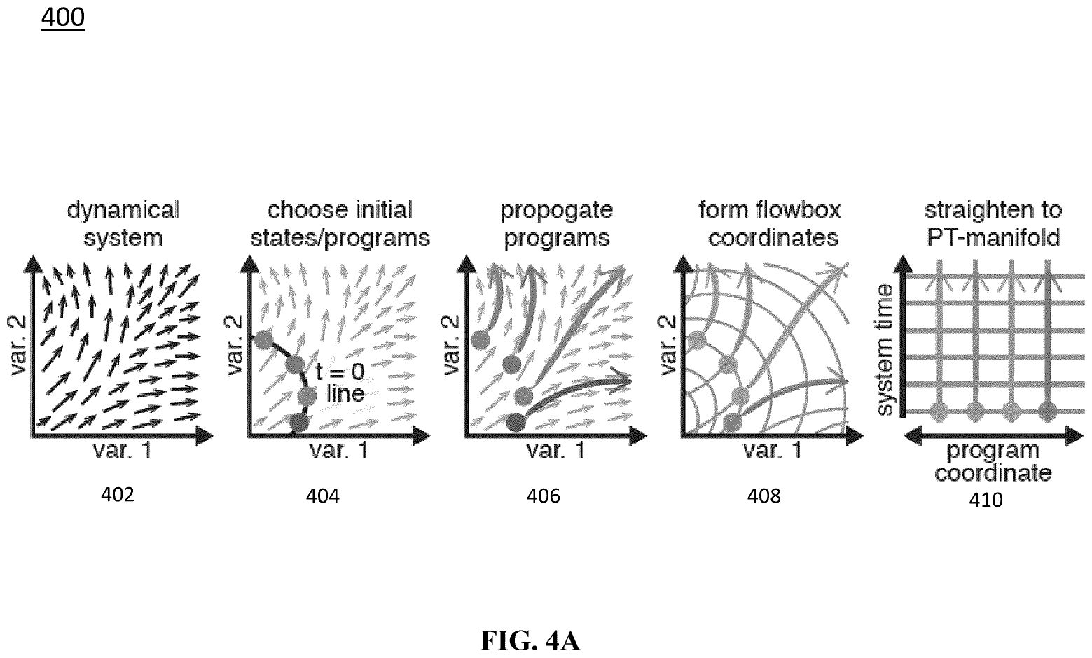

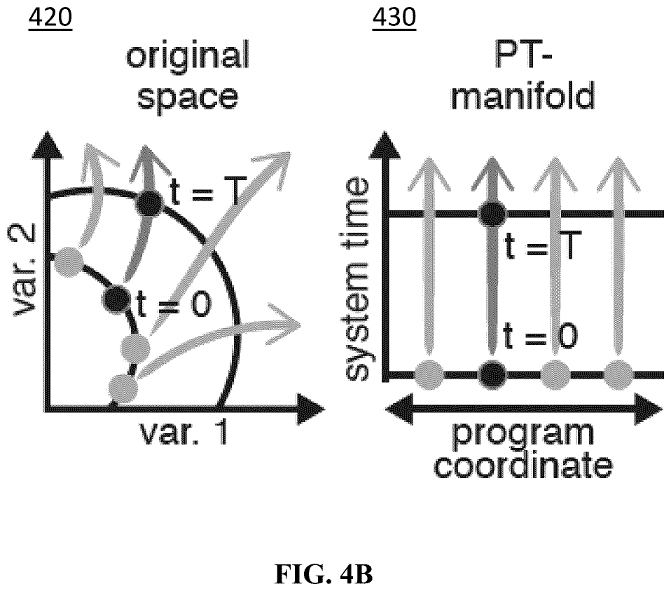

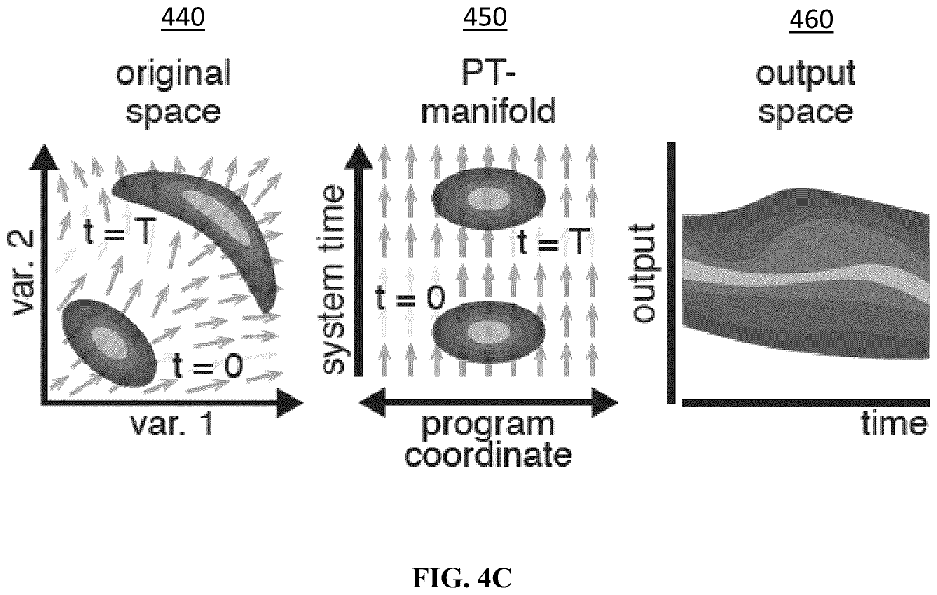

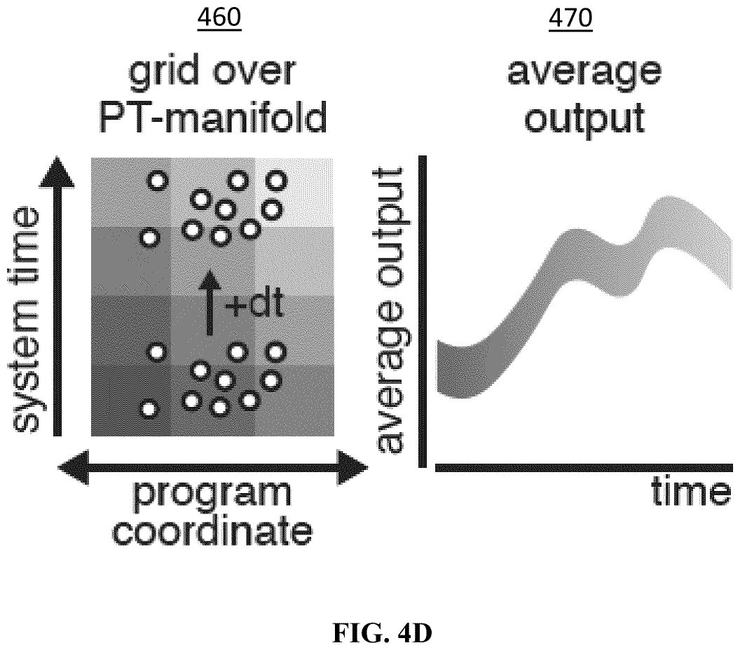

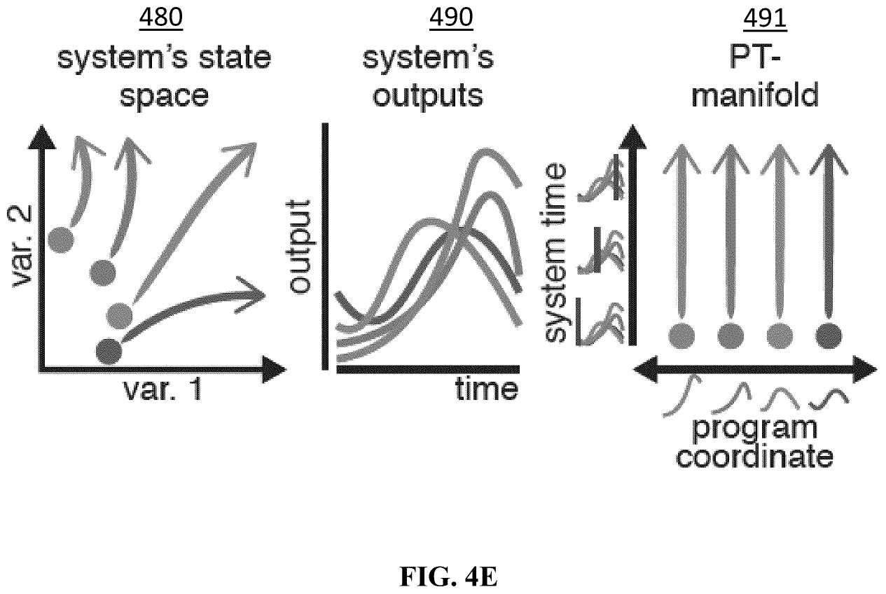

An exemplary process 400 of creating the PT-manifold is illustrated in FIG. 4A. In step 402, a dynamical system is represented by graphing two variables with respect to time. In step 404, initial states and/or programs are chosen. In step 406, programs are propagated to create general coordinates to represent the programs. In step 408, these program representations are used to form flowbox coordinates. In step 410, the flowbox coordinates are straightened to create the PT-manifold.

Two points in state space have the same program coordinates if, after some amount of time, the system's dynamics would drive the system's state from one point to another. This coordinate system requires denoting a set of points in state space as having system times of zero, with one such zero for each possible set of program coordinates. This then implicitly assigns the system time of any other point in state space as the time taken to traverse state space to reach that point from the relevant time-zero point. FIG. 4B illustrates a set of graphs 420 and 430 to choose the time-zero point in creating a PT-manifold.

This PT-manifold representation substantially simplifies the application of grid-based inference, particle filters, or other methods to state inference problems. Grids on the PT-manifold allow dynamics to be modeled, by construction, as simply shifting probabilities “forward” on the system time axis. FIG. 4C illustrates the creation of an output space 460, from an original space 440 to the created PT-manifold 450. By pre-calculating outputs at each grid point, this allows for rapid updating over time of probability distributions over the system's state and outputs. Particle filters are similarly simplified. In this representation, particles can propagated through the PT-manifold by simply adding the time elapsed between measurements to their position on the system time dimension.

Approaches can be further combined for a substantial optimization. By calculating grids of outputs over the PT-manifold, likelihoods and outputs may be evaluated by “snapping” particles at inference time to the nearest grid point. This replaces expensive evaluation of the output function with fast operations: rounding and look-up table evaluation. Importantly, these operations' speeds are invariant to the number of grid points, allowing access to fine approximations for outputs with no loss in speed. The underlying continuity of particle positions, however, approximates a continuous distribution over state space, and therefore yields subgrid resolution by averaging over particles across grid points over time. This operation is analogous to dithering in discrete graphics.

FIG. 4D illustrates a grid over the PT-manifold 460, as well as the associated average output over time 470.

This form of decoding, which is referred to herein as Gridded Inference using Dynamics on the Manifold of Program and Time (“GrID-MaPT”) is naturally interpretable. The PT-manifold has a well-defined relationship to the output. The program coordinates specify the pattern of outputs the system will produce over time; i.e., the “program” the system is running.

FIG. 4E illustrates the system's state space in graph 480, with system outputs 490 and the resulting PT-manifold 491.

Knowing the program coordinates allows us to predict what “sort” of output is being produced. In a chemical reaction, the program coordinates may specify the initial concentrations of various chemicals, thereby determining how the system will change over time. In a BMI application, the program coordinates would be more like the user's “intention,” specifying the pattern of outputs/action intended by the user. The system time is then “where” in the program the system is: how “far along” the chemical reaction is, or what “part of the action” the user is currently requesting. These two pieces of information are sufficient for GrID-MaPT to predict the system's output.

GrID-MaPT additionally simplifies learning the relationship between the system's outputs, measurements, and state. Due to the simple representation in the PT-manifold, any form of interpolation can be used to interpolate between training examples for both the system's outputs and parameters describing the measurement's probability distribution. Moreover, no observations of the state are ever needed to parameterize program coordinates. By definition, program coordinates specify the pattern of outputs produced over time. Correspondingly, under minimal assumptions, outputs over time serve as a complete representation of the initial position of the state in state space at t=0. By using any number of manifold learning techniques on output time series, program coordinates can be parametrized directly, without observations of the state. System time is correspondingly parameterized by real (external) time in the output time series. In this manner, parametrization and inference is directly performed on the system's state, without actually observing the state.

### Technical Details

The state of the system at time/can be denoted as z(t)∈R^{N}, the measurement of the state (which may be indirect) as x(t)∈R^{D}, and the output at y(t)∈R^{M}. The state is driven as a dynamical system:

$$\dot{z} ( t ) = f ( z ( t ) ) . \qquad ( 1 )$$

Realistically, it may be assumed that only measurements of the state are taken every δt. For convenience, the time base is defined such that δt=1. The output and the measurement of the system may then be written as two functions of the state:

$$y ( t ) = h ( z ( t ) ) , \qquad ( 2 )$$

$$P ( x ( t ) ) = g ( x ( t ) , θ ( z ( t ) ) ) . \qquad ( 3 )$$

In (3), the measurement is distributed according to a probability density (or mass) function g with parameters θ∈R^{d} (“measurement parameters”). As these parameters can change as a function of state, they may be written as θ(z(t)).

Denoting the flow of the state as the function φ that maps from an initial state, z(0), to the subsequent state at time t yields:

$$z ( t ) = z ( 0 ) + {\int }_{j = 0}^{t} f ( z ( j ) ) dj = ϕ ( z ( 0 ) , t ) . \qquad ( 4 )$$

This function is central to construction of the PT-manifold. In this single-point example, z(0) is one program, and ranging t away from 0 gives different points on the resulting trajectory, which correspond to different system times. Let's generalize. Let p be a point on an N0-dimensional manifold (with corners) M, 0<N0<N, that we assume is an N0-fold Cartesian product of circles S1 and line segments. Let Ψ be a one-to-one function that maps from M to R^{N} that is continuous and has an N-by-N₀ Jacobian ∂Ψ such that:

$$f ( Ψ ( p ) ) * \partial Ψ ( p ) = 0. \qquad ( 5 )$$

for every p, where 0 is the zeros vector and * indicates transposition. This restriction is that the surface defined by Ψ cannot align with the dynamics. This surface defines the surface of states with system time 0, and p is then the N₀ program coordinates. One last function that maps from program coordinates p and system time τ (to be distinguished from external, clock-time t) can be defined as:

$$Φ ( p , τ ) = ϕ ( Ψ ( p ) , τ ) . \qquad ( 6 )$$

Note that, for small enough range 0≤τ≤T, p and τ lie on a manifold with corners M×R that describes a “PT-manifold” in state space, and:

$$\frac{d Φ ( p , τ )}{dt} = \partial Φ ( p , τ ) {( 0 , 1 )}^{*} = f ( Φ ( p , τ ) ) . \qquad ( 7 )$$

In other words, the function describes a coordinate change on a portion of state space, and one that preserves the dynamics, though changing them to a simpler form.

Particle filtering in GrID-MaPT is performed by using a set of integers greater than zero representing grid bin-counts in the program coordinates and system time, such as the set of integers z₁, . . . z_{N}_{₀}, T. A set of “valid” indices and ranges as:

$${Z}_{ind} = \{ 1 , … , {z}_{1} \} \times \{ 1 , … , {z}_{2} \} \times … \times \{ 1 , … , {z}_{{N}_{0}} \} \times \{ 1 , … , {z}_{T} \} , \qquad ( 8 )$$

$${R}_{ind} = \{ 0 , {z}_{1} \} \times \{ 0 , {z}_{2} \} \times … \times \{ 0 , {z}_{{N}_{0}} \} \times \{ 0 , T \} . \qquad ( 9 )$$

R_{ind} describes a parameterization of the PT-manifold M×R, and Z_{ind} the coarseness of a grid over the PT-manifold. Let ceil ( . . . ) be a function that rounds each element of its input up to the nearest integer. Let

$$Y ∈ {R}^{{z}_{1} \times … \times {z}_{{N}_{0}} \times T \times M} and θ ∈ {R}^{{z}_{1} \times … \times {z}_{{N}_{0}} \times T \times d}$$

be two tensors of system outputs and measurement parameters. These two tensors are used as look up tables, to pre-calculate outputs and as much of the likelihood calculation as possible at each particles position.

Let {(pᵢ, τᵢ)}i=1 be a set of (particles, describing their program coordinates and system times. Each particle's coordinates are in R_{ind}. Prior to any measurements, each particle is initialized uniformly over R_{ind}. With each arriving measurement, the particles are propagated forward to reflect the increase in system time. Additionally, small amounts of noise are added to each dimension independently. In practice, this makes inference better-behaved. Mathematically, this takes the form for each particle i:

$$( {p}_{i} , {τ}_{i} ) := ( {p}_{i} , {τ}_{i} ) + ( 0 , 1 ) + ξ , \qquad ( 10 )$$

where ξ is a vector of random perturbations to the particle position (such as Gaussian- or Laplace-distributed noise). This occasionally causes particles to exit from R_{ind}, “falling off” the PT-manifold. This is addressed in one of three ways. For “circular” program dimensions corresponding to S^{l}, the modulo function is used to “wrap” particle position around the dimension. For line-segment program dimensions, particles are “bounced” off the upper and lower boundaries of the dimensions using an appropriate triangle-wave function. For the system time dimension, particles that land below 0 or above z_{τ} are uniformly re-distributed over R_{ind}.

After propagating particles, the likelihood of each particle under the observed measurement is calculated. To do so, the corresponding index-vector as:

$${J}_{i} = ceil ( ( {p}_{i} , {τ}_{i} ) ) ∈ {Z}_{ind} . \qquad ( 11 )$$

Then the likelihood of the observed measurement, x(t), associated with particle i is calculated as:

$${L}_{i} = g ( x ( t ) , Θ ( {J}_{i} ( 1 ) , {J}_{i} ( 2 ) , … , {J}_{i} ( {N}_{0} ) , {J}_{i} ( {N}_{0} + 1 ) , : ) ) \qquad ( 12 )$$

where: select all elements of an index. These likelihoods are then normalized to a probability distribution over particles. This probability measure approximates the posterior distribution over program coordinates and system time, given observed measurements. We further calculate the output associated with particle i as:

$${\hat{y}}_{i} = Y ( {J}_{i} ( 1 ) , {J}_{i} ( 2 ) , … , {J}_{i} ( {N}_{0} ) , {J}_{i} ( {N}_{0} + 1 ) , : ) . \qquad ( 13 )$$

This allows for the calculation of the expected system output as:

$$mean ( \hat{y} ) = {\sum }_{i = 1}^{U} {L}_{i} {\hat{y}}_{i} \qquad ( 14 )$$

and the covariance matrix as:

$$cov ( \hat{y} ) = {\sum }_{i = 1}^{U} {L}_{i} ( {\hat{y}}_{i} - mean ( \hat{y} ) ) {( {\hat{y}}_{i} - mean ( \hat{y} ) )}^{*} . \qquad ( 15 )$$

The particles are re-sampled with replacement, with the probability of sampling particle i given by Lᵢ. This entire process is then repeated for the next received measurement, effectively converting our previous posterior distribution into the subsequent prior distribution.

The procedure for grid-based inference in GrID-MaPT is largely analogous. In this case, the probability distribution is maintained using a tensor

$${P}_{z} ∈ {{R}^{{z}_{1} \times … \times {z}_{{N}_{0}}}}^{\times T} .$$

The actions or the dynamics are represented by shifting probability “forward” along the system time index:

$${P}_{z} ( i , j , … , k , τ ) := {P}_{z} ( i , j , … , k , τ - 1 ) . \qquad ( 16 )$$

Probabilities at the end of the system time index are distributed uniformly over the tensor. With each measurement, a likelihood tensor is calculated, such that:

$$L ( i , j , … , k , τ ) = g ( x ( t ) , Θ ( i , j , … , k , τ , : ) ) . ) \qquad ( 17 )$$

The probability tensor is then multiplied element-wise by these likelihoods:

$${P}_{z} := L ◦ {P}_{z} , \qquad ( 18 )$$

then re-normalized to sum to 1. This step corresponds to performing Bayesian inference over position on the PT-manifold. The expected system output can then be calculated as:

$$mean ( \hat{y} ) = {\sum }_{i , j , … , k , t} {P}_{z} ( i , j , … , k , t ) Y ( i , j , … , k , t , : ) . \qquad ( 19 )$$

and subsequent moments of the distributed calculated accordingly.

GrID-MaPT requires a parameterization of the PT-manifold, and a method calculating grids at each point of measurement parameters and outputs. To make this formal, let the training set be a set of q trajectories in state space Z₁, Z₂, . . . , Z_{q}∈R^{N×T}, corresponding measurement parameters of the state X₁, X₂, . . . , X_{q} ∈R^{D×T}, and cor-responding outputs Y₁, Y₂, . . . , Y_{q} ∈R^{M×T}. It is assumed for the moment that the initial points of each of the trajectories in state space are not part of the same orbit over short enough time scales. This assumption may be relaxed later. The first columns of each matrix of trajectories, Z₁, (:, 1), Z₂ (:, 1), . . . , Z_{q}(:, 1)∈R^{N} then serve as a discrete skeleton for the image of Ψ, meaning that domain can be recovered any standard manifold learning techniques. Let p¹, p², . . . , p^{q}∈R^{N}^{₀} be the inferred program coordinates learned from Z_{1,1}, Z_{2,1}, . . . , Z_{q,1} by a manifold learning technique. The system time representation is just the set {1, 2, . . . , T}. Y and Θ can then be learned by using fitting a parametric or non-parametric interpolators mapping from the PT-manifold to the associated outputs and measurement parameters in the training set, evaluating these interpolators at a pre-established grid points, and assembling these evaluations into tensors.

In this case that lacks observations of the initial states of the system, GrID-MaPT can still be used. Rather than performing manifold learning on the initial states Z₁, (:, 1), Z₂ (:, 1), . . . , Z_{q}(:, 1)∈R^{N}, vectorizations of the output matrices, vec(Y1), vec(Y2), . . . , vec(Yq)∈RMT can be substituted. In general and exactly as the name “program coordinates” suggests, the system's outputs over time can contain complete information about the system's initial state. To demonstrate this, let z0 be an initial state in the system's state space, let z(t)=φ(z0, t), and let the system's output y(t)=h(z(t)). The derivative of the system's output with respect to its initial state is:

$$\frac{dh ( z ( t ) )}{{dz}_{0}} = \partial h ( z ( t ) ) \frac{d ϕ ( {z}_{0} , t )}{{dz}_{0}} , \qquad ( 20 )$$

where ∂h(z(t)) and ∂f(z(j)) are the Jacobians of the output and dynamics functions respectively, and dφ(z₀, t)/d_{z}_{₀} is the N-by-N “sensitivity matrix”. The sensitivity matrix, for smooth dynamics, is guaranteed to be full-rank. Under the minimal assumption that the Jacobian of the system output explores N independent dimensions, across all t≥0 this derivative will be rank N, meaning the system's output over time can be used to detect small changes in the initial state. While this only proves that system outputs over time and local portions of state have a one-to-one relationship, it suggests that manifold learning on outputs-over-time can be used to parameterize program coordinates, and the system's state space more broadly. In other words, the state of the system at t=0 and the system's output over time have a one-to-one relationship.
Decoding Movement from Neural Activity with GrID-MaPT

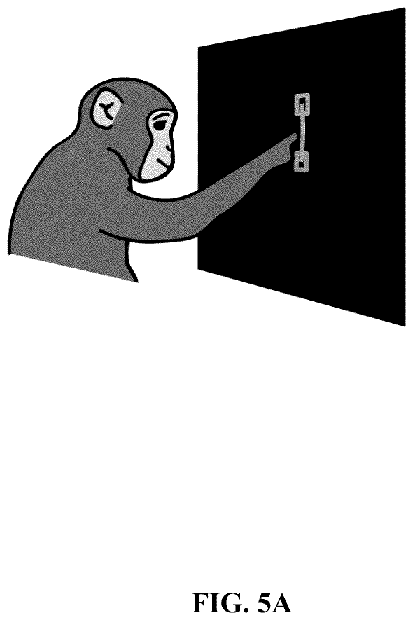

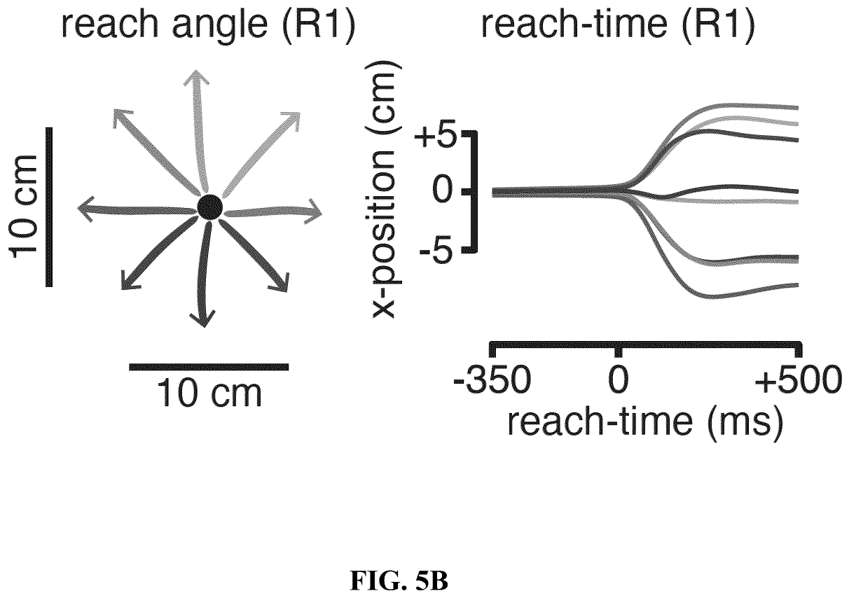

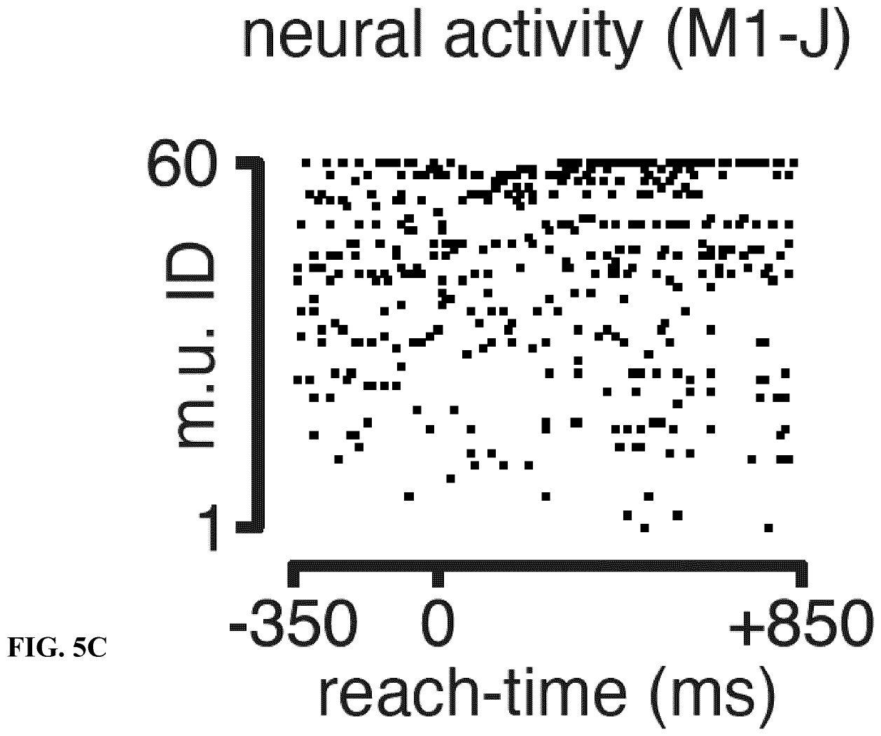

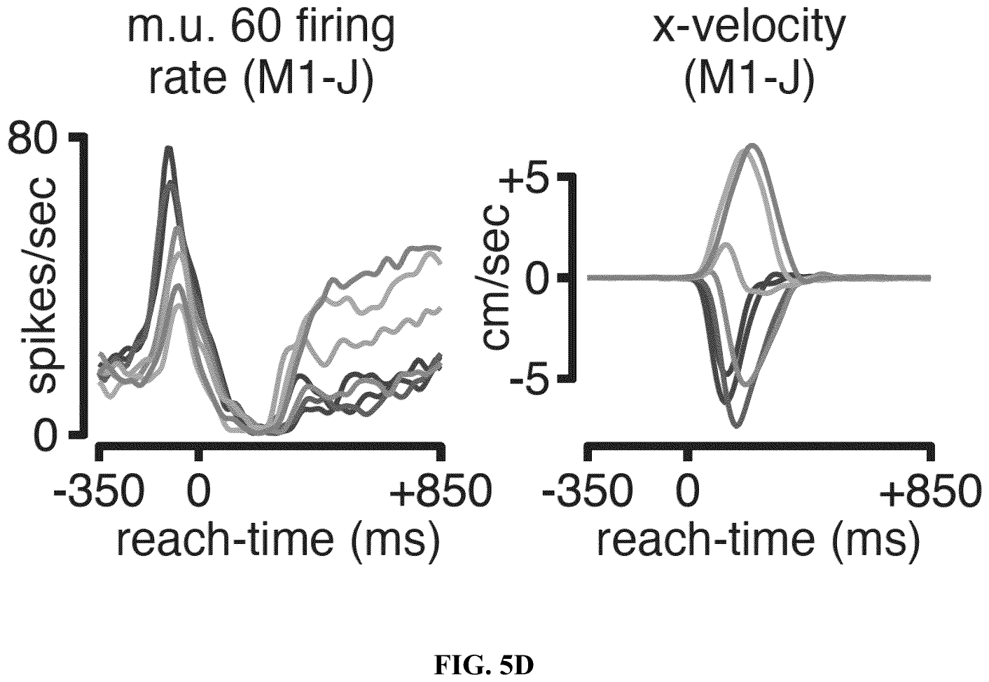

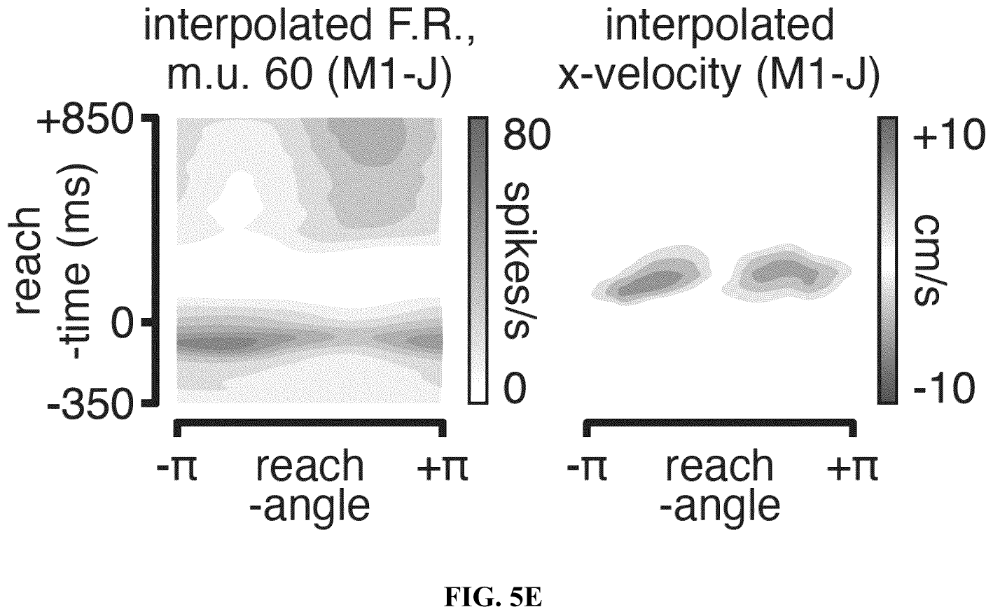

In light of growing interest in Brain-Computer Interfaces (BCIs), GrID-MaPT can be applied to decoding arm movements performed by rhesus macaques in reaching tasks. An example macaque movement is shown in context of a cartoon in FIG. 5A, as well as the corresponding reach angle and time in FIG. 5B. This problem is well-studied but remains very challenging for several reasons: measurement of the monkey's neural activity is limited to only tens to hundreds of neurons from one or a few of the numerous relevant regions of the brain, these neurons “spike” at limited rates, this spiking is noisy, and neurons may have nonlinear relationships with the movement kinematics. In these tasks, the monkey first holds a central fixation point, then is presented with a visual target but not yet allowed to move. After a variable delay a “go cue” is given, and the monkey makes a rapid reach to the target.

The process begins by decoding hand velocity during a simple task, in which monkeys were trained to reach from a central fixation point to a cued target on a ring of possible targets (the “center-out” task, illustrated in FIG. 5A). The PT-manifold is parametrized by the angle of the target from the fixation point and the time relative to the beginning of the monkey's reach (“reach-time”). These two pieces of information are enough to specify the hand velocity of the monkey at any point in the task, and therefore are also a complete description of the state of the outputs of the monkey's motor system.

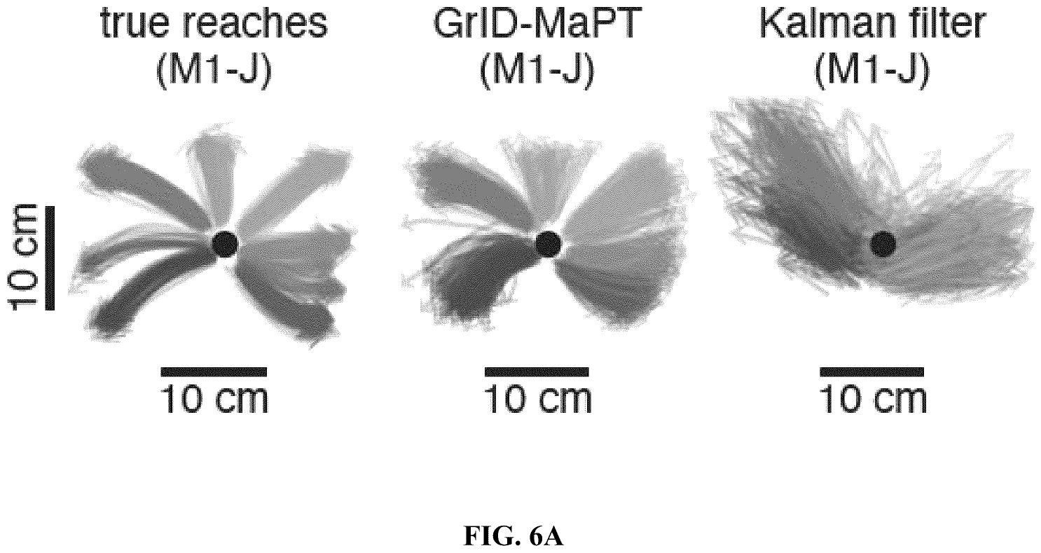

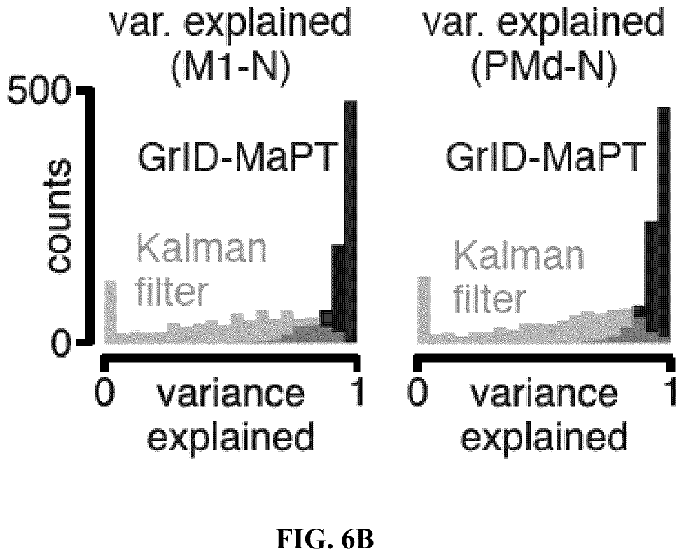

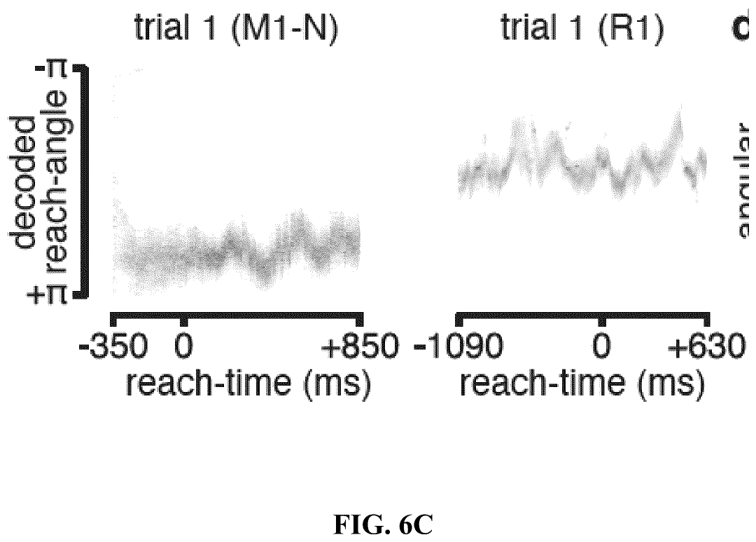

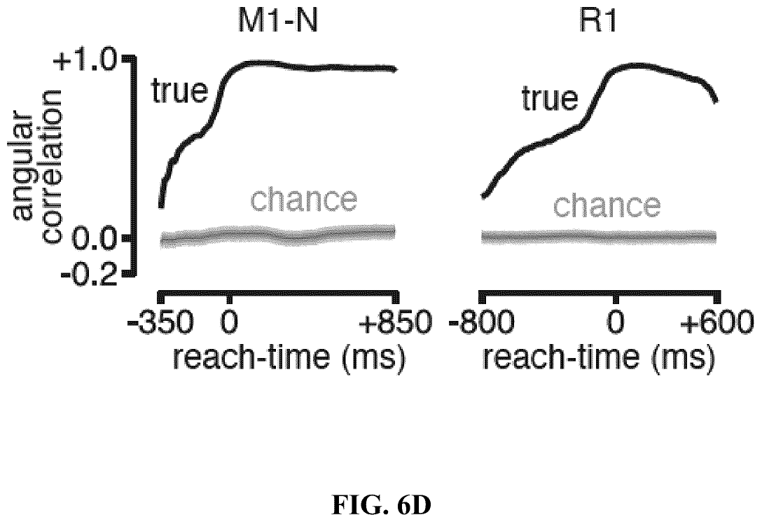

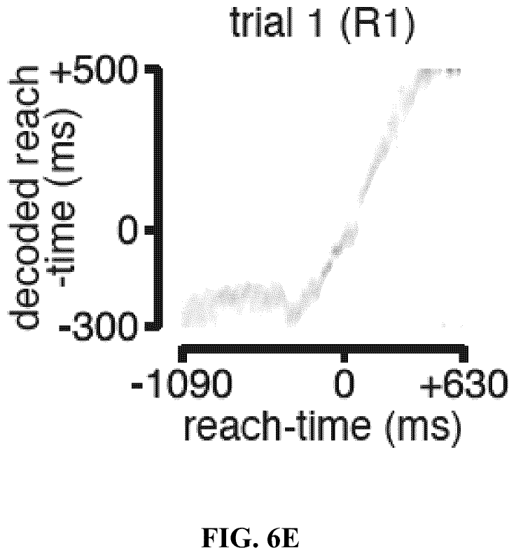

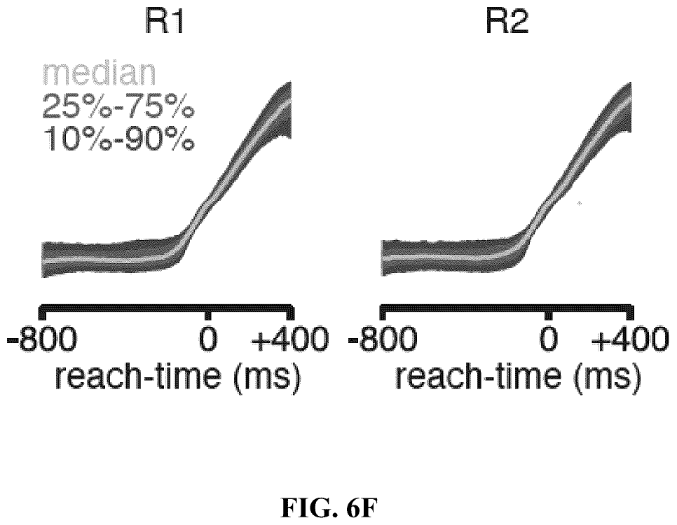

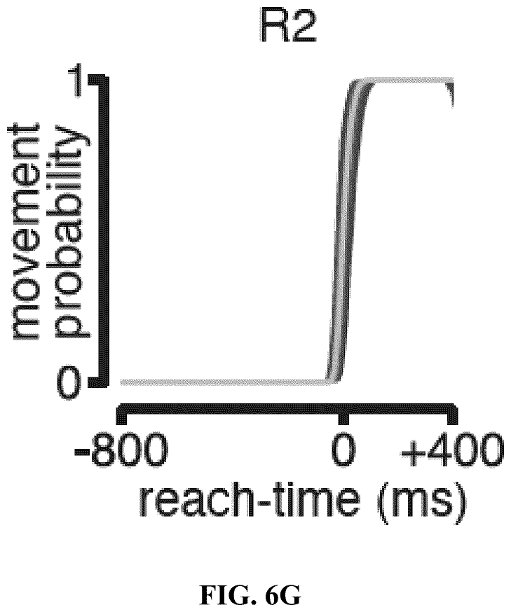

The neural measurements are the simultaneously-recorded spiking activity of 40-60 “multi-units” recorded from primary motor (M1) and dorsal premotor (PMd) cortex, as illustrated in FIG. 5C. These measurements constitute six datasets from three monkeys: activity in M1 or PMd in monkey J (referred to in FIGS. 5C-E as M1-J, PMd-J); activity in M1 or PMd in monkey N (M1-N, PMd-N); and activity in M1 and PMd in monkey R on two different sessions (R1, R2); this is illustrated in FIG. 6C. Spike-counts are modeled as Poisson-distributed, with time- and angle-varying firing rates for each neuron. For each monkey, reaches to 7 or 8 approximately-equidistant angles are used as training data, and each neural unit's data were averaged and smoothed to produce firing rates, as illustrated in FIG. 5D. These firing rates and associated hand velocities are interpolated over angle and time (over the PT-manifold) using bi-cubic interpolation, and subsequently gridded, as shown in FIG. 5E. Fitting and evaluating the grid could be completed in a few seconds on a consumer laptop. GrID-MaPT's ability to infer hand velocity over time can then be tested on reaches to a separate group of targets. An illustration of the measurement of true reach using GrID-MaPT as opposed to Kalman filters and true reach measurements is shown in FIG. 6A.

While decoding with GrID-MaPT, a particle filter is used to localize the state on the PT-manifold, and output the expected hand velocity. Using a thousand particles, decoding is performed fast enough for real-time inference: spike counts were binned at 10 ms resolution as is typical in BCI applications, while each inference step in GrID-MaPT takes approximately 3-5 ms. Using GrID-MaPT, 88-94% of the variance in the monkey's hand position is inferred over time (s.d. <13%), significantly more than could be inferred with a Kalman filter (average 26-68% variance explained; Wilcoxon Signed-Rank test, p<0.001). This is illustrated in FIG. 6B. Decoded reach angles in trial 1 is also shown in FIG. 6C, with further data shown comparing true vs. chance correlation in FIG. 6D and decoded reach time in FIG. 6E. FIG. 6F illustrates a median reach time over the two different sessions R1 and R2. The movement probability as a function of reach-time is shown in FIG. 6G. Using a final decoded hand position with GrID-MaPT correlated strongly with the monkey's final hand position in both in x- and y-dimensions (Pearson's rho, 0.88-0.97). GrID-MaPT therefore allowed fast and precise decoding of reaching movements from neural activity.

The key feature of GrID-MaPT is that it decodes by inferring a probability distribution over the position of the system's state on the PT-manifold. Consistent with the preceding high-fidelity decoding of hand velocity, GrID-MaPT is found to identify the target angle with increasing accuracy approaching movement onset, with maximal circular correlations of 0.85-0.96 between the true and decoded target angle reaching, significantly above chance (shuffle, p<0.001). Similarly, it is found that 200 ms prior to movement onset until 400 ms after movement onset, reach-time decoded by GrID-MaPT strongly correlated with actual reach-time (Pearson's rho, 0.91-0.98, p<0.001). It is further observed that, no matter how long the monkey waited before reaching, GrID-MaPT stably decodes the onset of the reaching sequence ˜200-300 ms prior to reach onset, indicating GrID-MaPT could flexibly decode variable monkey behavior. This fact can be utilized to decode whether or not the hand was moving with almost perfect accuracy (classifier accuracy, 0.92-0.96), significantly above chance (shuffle, p<0.001), with the decoded probability of movement rising sharply at actual movement onset. It is noted that this accurate decoding of time was not dependent on strong priors or task structure: all decoders are initialized with uniform priors over reach-time, and data from monkey R included variable delay periods of 540-1500 ms.

These results are replicated with two datasets, recorded from M1 and PMd in monkey N, in which monkey N reaches to targets while avoiding virtual barriers. This task (“complex center-out”) evokes more complex curved reaches. GrID-MaPT is identically used to decode hand velocity from the activity of 60 multi-units from each area. For this task, parameters were added to the PT-manifold to include reach curvature in x- and y-dimensions, to account for the greater complexity of the reaches. Grids are fit and evaluated over firing rates in this task using linear-quadratic regression.

Similarly to in the standard center-out task, 87-90% of the variance in the monkey's hand position can be decoded over time (s.d. <15%) using GrID-MaPT, significantly more than could be inferred with a Kalman filter (average 56-60% variance explained; Wilcoxon Signed-Rank test, p<0.001). Again it was found that decoded target angle increasingly strongly correlated with true target angle around reach onset, with maximal circular correlations of 0.9-0.93 between the true and decoded target angle reaching, significantly above chance (shuffle, p<0.001). It was also found that 200 ms prior to movement onset until 400 ms after movement onset, reach-time decoded by GrID-MaPT strongly correlated with actual reach-time (Pearson's rho, 0.95-0.97). Additionally, decoded reach curvature was increasingly accurately decoded around reach onset, with maximal correlations of 0.87-0.99 and 0.66-0.77 x- and y-dimension curvature respectively, significantly above chance (shuffle, p<0.001). Given all program coordinates were accurately predicted by GrID-MaPT, how well the system could predict the entire movement at any moment in the decoding was tested. Variance explained in hand position over time rose strongly up to movement onset, peaking approximately around movement onset with an average of 86-87% variance explained (s.d. <16%), significantly above chance (shuffle, p<0.001). GrID-MaPT accurately decoded reaching movements from neural activity, even for curved reaches in which moment-by-moment hand velocity was dissociated from reach target.

Continuous Decoding with GrID-MaPT

Some embodiments of the present disclosure include decoding from a system in which the system's programs (reaches in a carefully-designed task) were discrete, containing a definite start and stop. Most systems, however, continuously vary their outputs over time. In this sense, most systems run “never-ending” programs, with their states continuously traversing state space. In any system with a state confined to a finite portion of state space, this means that parts of the PT-manifold must pass arbitrarily closely in state space, or actually overlap. While this identification of overlapping portions of the PT-manifold may seem problematic, it can instead be leveraged to decode systems that run “never-ending” programs. Using a PT-manifold long enough to self-intersect allows the identified state, after exceeding the (arbitrarily chosen) maximum end of the system time dimension, to rapidly re-localize on the time-zero portion of the PT-manifold.

To demonstrate this capability, GrID-MaPT is applied to a toy neural system. A Lorenz system, a 3-variable dynamical system with a state canonically denoted (x, y, z) can be used. The output of the system is assigned as z. For measurement, 80 linear combinations of x and y with Gaussian distributed weights were sampled and rectified, and treated as firing rates underlying the spiking activity of artificial “neurons”. This system is chosen for several reasons. Firstly, the Lorenz system evolves chaotically, making it a worst-case scenario for state localization. Secondly, the dynamics of the Lorenz system are highly nonlinear, making it a suitable test of GrID-MaPT's ability to adapt to arbitrary dynamical systems. Thirdly, this is an incompletely observed system, testing GrID-MaPT's ability to infer unobserved components of the dynamical system. Finally, the x and y variables are almost (linearly) uncorrelated with the z variable that is chosen as the desired output, meaning that the measurements of the system would be completely ineffective for standard linear methods such as a Kalman filter to infer the system outputs. Therefore, GrID-MaPT's ability to adapt to nonlinear outputs of the system's state can be demonstrated.

To parameterize the PT-manifold, snippets are randomly cut from a long trajectory of the system to serve as programs. The temporal duration of the programs determine the length of the system time dimension of the PT-manifold, so programs of sufficient length are used so that the PT-manifold would self-intersect in state space. Correspondingly, recorded associated “firing rate” measurements and outputs of each program are recorded. To parameterize the program coordinates of the system's PT-manifold to simulate ignorance of the “correct” parameterization, a singular value decomposition is used to calculate an optimal linear embedding of the outputs associated with each program. Interpolation is then performed over the PT-manifold using 2-nearest-neighbor regression with inverse-distance weighting.

Ten such systems are generated, randomly choosing the weights linking the underlying system to the measured “neurons” for each system. GrID-MaPT is then used to infer outputs over time on a separate test trajectory, with the length of the trajectory far longer than the snippets used to fit GrID-MaPT. The outputs inferred by GrID-MaPT strongly correlated with the true system outputs (Pearson's rho, 0.88-0.95). This is the case despite the chaotic nature of the dynamics, and despite GrID-MaPT not being trained with trajectories nearly this long. Nevertheless, GrID-MaPT accurately decoded the aperiodic outputs for the system. Consistent with the description of decoding never-ending programs with GrID-MaPT, it is observed that inferred program coordinates tend to remain static and internal system time increases in proportion to the external system's time for long periods, before rapidly dispersing and re-localizing at alternate portions of the PT-manifold.

There are close analogs of this problem for real applications. For example, in a BCI, one might wish to train the decoder using a modest number of brief, instructed movements, then run the resulting decoder continuously for long periods of time so that the user can interact with a computer or control a robot at their own pace.

It will be appreciated that GrID-MaPT may be used in a variety of additional applications. An exemplary set of further examples are provided below.

Another example application is for user input devices for virtual reality (VR) or augmented reality (AR). In these contexts, the VR/AR system must receive information about what movements the user is making to enable the user to interact with virtual objects. However, the sensors available for doing so are generally indirect, meaning that they do not measure any or all of the desired movements directly; and/or are noisy, with the noise typically state-dependent. Common sensors include accelerometers, which are noisy and relate nonlinearly to the movements of interest; electromyographic bracelets for detecting muscle activity in the forearm, which are noisy and very nonlinearly related to the movements of the hand; magnetic position sensors, which are noisy in a state-dependent way and nonlinearly related to movement; and video tracking, which has state-dependent noise depending on the body's position relative to the cameras. GrID-MaPT has properties that improve inference for each of these sensor types: it naturally learns the nonlinearities between the measured sensors and the state variables (such as the hand configuration and position), naturally handles state-dependent noise, can infer dimensions of the state that relate only indirectly to the measured outputs (here, the sensor readings), and can implicitly learn to exploit the dynamics of the particular's users biomechanics to denoise optimally for that user.

Another example application is for robotics or aerospace. In these cases, a robot, aircraft, or rocket must be controlled, and the necessary control signals depend heavily on the current state of the system. This state is typically inferred from combining the current belief about the state with sensor readings, which unavoidably have noise, and which also relate nonlinearly to the state. Even in cases where the state parameters of interest may be measured relatively directly, recent movements or forces may cause flex or other elastic motion, or slosh of internal fluids that cannot be measured directly and yet may be important for choosing ideal control signals. GrID-MaPT naturally learns not only the nonlinear relationships between sensor readings and state variables, but also the nonlinear state interactions such as flex or slosh in the structure of its dynamics. This may result in better state estimation, and therefore enable better control and/or better prediction of impending failure. The efficient training of GrID-MaPT may also allow calibration to each individual instance of a robot/aircraft/rocket, and the rapid inference permits use where state inference must occur in milliseconds. Finally, because of interpretability, it is possible to inspect GrID-MaPT for dangerous failure modes, which is critical for controlling equipment on which lives depend.

Another example application is in prediction of financial markets. Markets partly reflect underlying state variables in the world, such as when a futures market depends on global wheat harvest yields; state variables in other investors, such as optimism or liquidity; and dynamics, where aspects of the market may be cyclical, have “inertia”, or tend to rebound, or when markets interact in non-obvious ways. Because of these facts, Kalman filters are widely used in financial market modeling. GrID-MaPT may provide superior performance in some markets, where the system may be modeled as low-dimensional but highly nonlinear. Because GrID-MaPT is efficient with training data, it may learn to handle rare events better or can be retrained quickly when fundamentals change. In addition, relative to neural networks, GrID-MaPT can use a parameterization chosen by the user (though this is not a requirement), allowing the user to both read out GrID-MaPT's “beliefs” about the state of the market and input additional information or run simulations in readily interpretable ways.

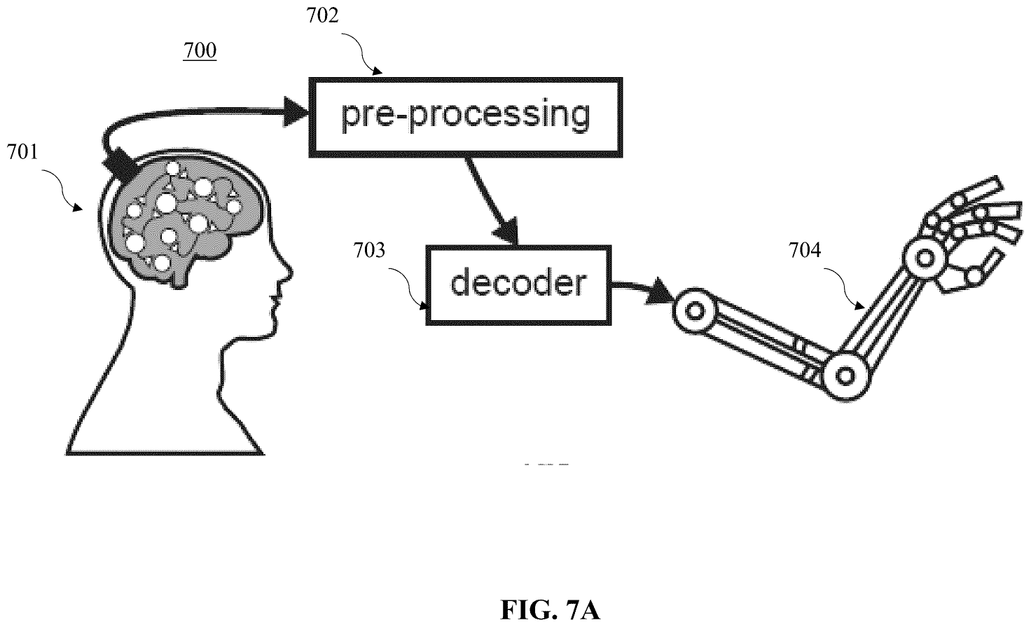

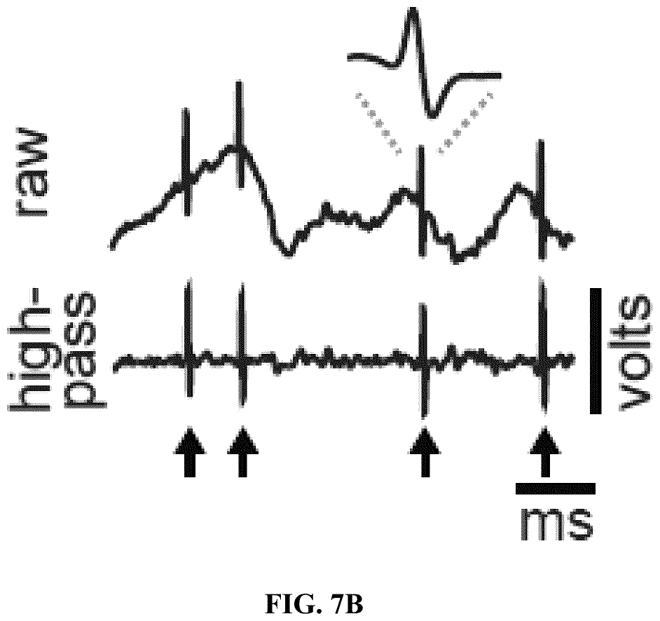

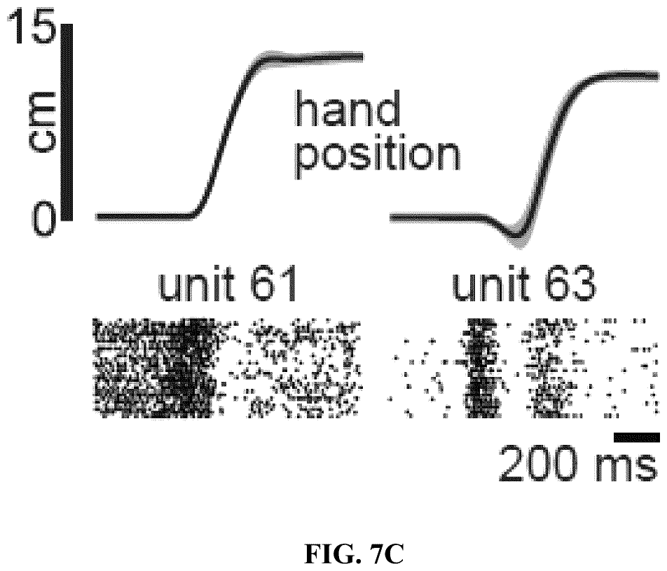

Brain-Machine Interfaces (BMIs), similar to BCIs, are systems that use signals from the brain to control a computer, robotic arm, or other device (i.e., “effectors”, such as the robotic arm as shown in FIG. 7A). At the core of BMIs are algorithms (“decoders”) that translate signals from the brain into control signals that are used to control an external device (“decoding”). It is known that the firing rates of neurons in motor areas (the “population state”) collectively encode movements of the arm and hand. Using recorded neural activity for decoders is challenging, however, because only a modest number of the neurons in the brain at one time can be recorded and because these signals are intrinsically noisy. Neural populations act like a “dynamical system”: the current population state strongly predicts the population state a few moments later. Prior decoding algorithms have leveraged only the instantaneous relationship between neural activity and movement. There is a need for a method that is not dependent on calculating a dynamics model in real time, which slows down inference decoding.

These interfaces have immediate clinical applications. For example, BMIs have been proposed in particular to aid patients suffering from movement deficits such as spinal cord injury or ALS, by allowing them to bypass the injured peripheral nervous system to control a robotic limb or other external effector directly with their brain. At the core of BMIs are “decoders”: algorithms that translate signals from the brain into outputs used to control the effector. One important class of BMI uses electrical signals recorded from electrodes invasively implanted in the brain as input. These signals are pre-processed to isolate neural action potentials (“spikes”; FIG. 7B). Decoders take these spikes as input, often using the activity of multiple neurons, and convert them into command signals to control an effector.

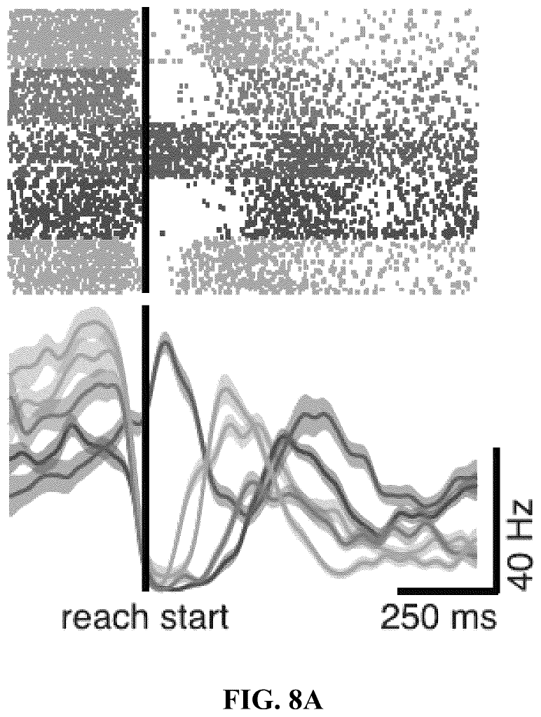

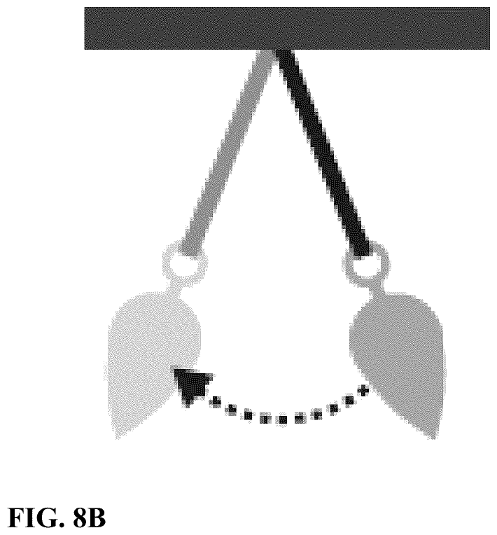

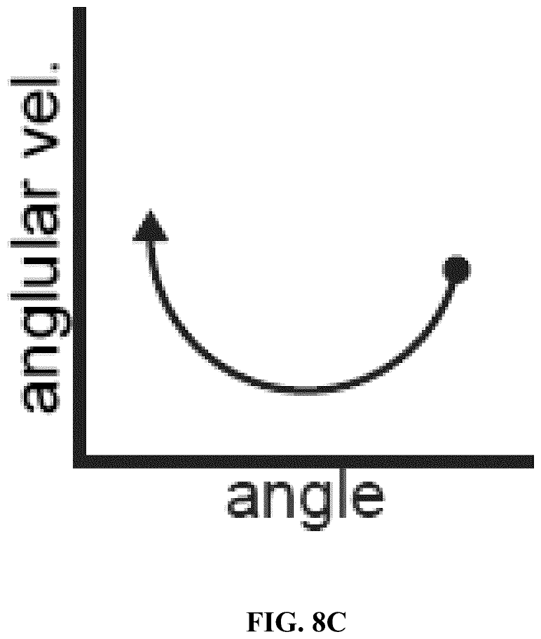

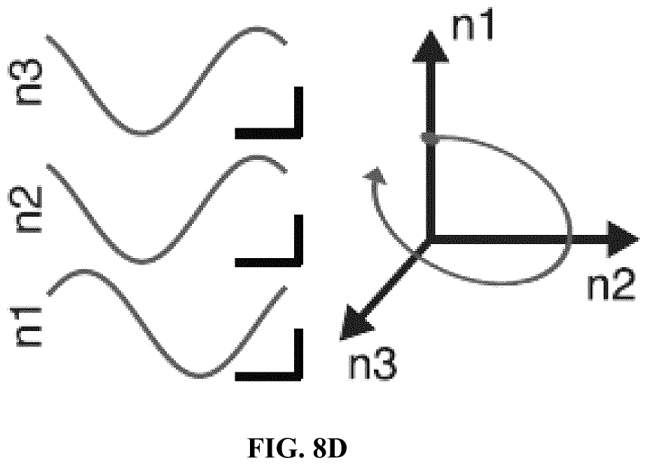

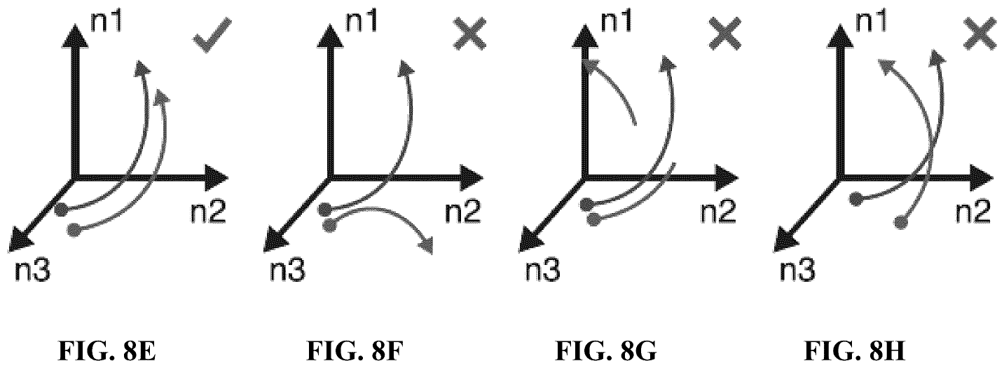

It is known that the frequency at which single neurons spike over a period of time correlates with variables in the external environment. Previous decoders have made use of these correlations by taking weighted linear combinations of binned spike counts to decode external variables, such as arm velocity. The decoded signals are often further smoothed, such as with Kalman filtering or exponential smoothing. Once fit, these decoders have been used to control effectors, such as a prosthetic or cursor on a screen. These decoders have primarily faced two challenges. The first challenge is that neurons' spiking activity is “noisy”. Over multiple identical arm movements, for example, the exact pattern of spikes output by any single neuron differ (FIG. 7C). Neurons are accordingly modeled probabilistically, with variable spike trains thought to noisily reflect a latent “firing rate” (FIG. 8A). This noise can cause command signals to fluctuate undesirably. The second challenge lies in assuming a linear relationship between external variables and the neurons' firing rates. Although the neural activity correlates with external variables such as arm velocity, this relationship is often nonlinear. When approximated as linear, relationships between neural activity and external variables can therefore be unreliable at short time scales and vary with context. This nonlinearity has therefore often led to poor fitting of the decoder models.

Embodiments of the present disclosure use a two-step procedure to decode signals from neural populations. First, data may be represented jointly using the neural population activity over time and the desired external control signals (including, but not limited to arm/hand movements). These representations are interpolated to form a continuous manifold. Importantly, this manifold both parameterizes a continuous space of control signals over time, and parameterizes a continuous manifold in the space of possible neural population states. When the control signal is encoded, parameters encoding the movement itself (the “condition”), and the relative time in the condition (e.g., “30% of the way through the movement”) are included. As such, the neural activity is a function of the angle being reached and the relative moment in time. This means that dynamics in the manifold can be expressed simply as time moving forward, which corresponds to complex changes in the neural activity captured by the parameterization disclosed herein. This manifold is then gridded to create a discrete approximation to the continuous manifold.

Second, to decode new neural data, embodiments of the present disclosure probabilistically infer a position on the manifold grid from binned spike counts of the recorded neurons. At each point in time, embodiments of the present disclosure output the corresponding values of control signals. To incorporate the dynamical system aspect, a probability distribution is propagated over the grid over time using Bayesian Recursive Estimation. This inference is itself done in two steps. First, the probability distribution over the grid at the last timepoint is moved forward one step in time, and convolved with a user-specified probability distribution representing uncertainty in the estimate. Second, each grid-point is assigned a likelihood of producing the observed spike counts from the associated population state. The population state encodes “what” reach is occurring, as well as “when” in that reach it is occurring. This works whether or not the population actually encodes reach kinematics, and is robust to the transformation between neural activity and movement. This likelihood is then multiplied at each grid point with the previous probability distribution, and the resulting values normalized to produce a new probability distribution. The decoded position on the manifold is then inferred as the maximum likelihood estimate (e.g., the grid-point with the highest probability), and the corresponding values of control signals are outputted. This results in a stream of spike counts from a neural population being decoded into a time series of control signals.

By using interpolation, embodiments of the present disclosure are able to perform few-shot generalization from a small number of training example to decode a large space of control signal values over time. By constraining the population state to a manifold, and assuming dynamics on this manifold, embodiments of the present disclosure are able to more accurately infer population state, and therefore produce more reasonable control signal values over time. Embodiments of the present disclosure are well-suited in particular to “motor” applications such as producing control signals for neural prosthetics in patients with tetraplegia, an active area of research and one which several major companies are doing development.

Embodiments of the present disclosure improve over current processes in several ways. First, the present disclosure decodes control signals from neural activity at higher fidelity than existing technologies. Second, embodiments of the present disclosure use scientific hypotheses about the brain to produce a decoder that decodes in an interpretable manner. Third, the decoder uses interpolation to generalize from a relatively small training set.

As research has sought to understand the complex activity present in motor cortex, it has been suggested that certain areas of the brain act as “dynamical systems”. Dynamical systems obey rules governing how their “state” (a set of variables) change with time. One simple example of a deterministic dynamical system is a pendulum, which can be quantified by two variables: the current angle and the velocity of the pendulum (FIG. 8B). These variables define a “state space” which captures all possible states. In the case of a pendulum, the state space is a 2-D plane with one axis for angle and another for velocity (FIG. 8C). The “rules” of the dynamical system (the “dynamics”) define how the state moves through state space.

FIGS. 7A-C illustrate brain-computer interfaces allowing neural activity to control external devices. FIG. 7A is an exemplary illustration of a BMI 700 using neural activity to control an external effector, here a prosthetic arm. As shown, the BMI 700 includes a series of brain signals 701 are received at a preprocessing step 702. The processed signals are then sent to a decoder algorithm 703 before sending a control command to an effector 704.

FIG. 7B is an exemplary illustration of extracellular recordings of local potentials (as shown in the “raw” graph). The local potential recordings allow for the isolation of action potentials after high-pass filtering (as shown in the “high-pass” graph), which can be detected via threshold crossings indicated by the series of arrows. The inset wave demonstrates an example of a spiked waveform.

FIG. 7C is an exemplary illustration of a mean and standard deviation of a hand position of a rhesus macaque during movements, and a multi-unit spiking activity on the execution of the same movements. The mean is shown by the graph line in cm, and the standard deviation is shown by the shading around the mean.

### Dynamical Systems

FIGS. 8A-H illustrate smooth dynamics generating neural activity. FIG. 8A is a pair of graphs depicting exemplary activity of a unit in a macaque motor cortex for different reaching movements (colored by reach angle). Motor cortex activity during reaching is driven by recurrent dynamics, where current firing rates predict future firing rates. The motor cortex trajectories in state space linearly encode for reach kinematics, which can be decoded by a sequence-to-sequence decoder (not causal).

Spiking activity on single executions of the same movement is shown on the top graph, while the movement-specific firing rate is shown on the bottom graph. The line on the bottom graph represents the mean value for the spiking neural activity, while the shading around the line represents the standard deviation. The vertical line as shown indicates movement onset. Different colors throughout the graphs indicate different movements.

As research has sought to understand the complex activity present in motor cortex, a recent approach has suggested that certain areas of the brain act as “dynamical systems.” Dynamical systems obey rules governing how their “state” (a set of variables) change with time. One simple example of a deterministic dynamical system is a pendulum, which can be quantified by two variables: the current angle and the velocity of the pendulum (FIG. 8B). These variables define a “state space” which captures all possible states. In the case of a pendulum, the state space is a 2-D plane with one axis for angle and another for velocity (FIG. 8C). FIG. 8B and 8C illustrate a pendulum action and the corresponding state space represented by angular velocity as an angle measurement.

The “rules” of the dynamical system (the “dynamics”) define how the state moves through state space. By repeatedly applying these rules, the state traces out a trajectory through state space over time. In the pendulum example, the rules define simple interactions between the angle and velocity of the pendulum. In the case of a population of neurons, the state variables are often taken to be the firing rates of the neurons. This means that the “neural state space”, for n neurons, is an n-dimensional space where each axis is the firing rate of a single neuron (FIG. 8D). FIG. 8D is an exemplary graph illustrating the firing rates of three exemplary neurons (n1, n2, and n3) and their resulting trajectory in a neural state space formed by the firing rates over time. Each point in this space represents a “population state”, or a configuration of firing rates across neurons. As a dynamical system, the current population state determines the future population state. The dynamics therefore cause the population state to trace out a trajectory over time. Several studies have noted that neural dynamics are “smooth”: similar population states lead to similar future population states, and the population state does not jump to faraway points (FIGS. 8E-G). Trajectories in neural state space are smooth. Trajectories further cannot be “tangled”: as the current state determines future states, trajectories cannot cross (FIG. 8H). The dynamical systems framework has been useful for explaining changes in firing rates before movement. Preparatory activity (activity preceding movement, when the desired movement is known) is hypothesized to initialize the population state to the correct point in neural state space, so dynamics then produce the trajectory in neural state space appropriate for the desired movement.

FIGS. 8E-H are a series of graphs showing neural trajectories. In neural state space trajectories are smooth, with similar population states leading to similar trajectories (FIG. 8E). Trajectories do not diverge from similar initial population states (FIG. 8F), do not jump to new states discontinuously (FIG. 8G), and do not cross (FIG. 8H).

Knowledge of a dynamical system can enable removing the noise from the signal in noisy data sets. To continue the example of a pendulum, suppose that sensor noise prevents accurate measurements of the pendulum's angle and velocity at each point in time. Dynamics entail, however, that the angle and velocity of the pendulum do not need to be inferred from each measurement independently.

Knowledge of the pendulum's dynamics, together with multiple measurements over time, enable a more accurate estimate of the pendulum's angle or position at each time point. Similar advantages could apply to decoding from the brain: considering neural activity over time, along with an understanding of dynamics underlying neural activity, could help to “see through” the noise in neural recordings. This principle has been used successfully in other applications.

Applying Dynamical Systems to Decoding from Neural Activity

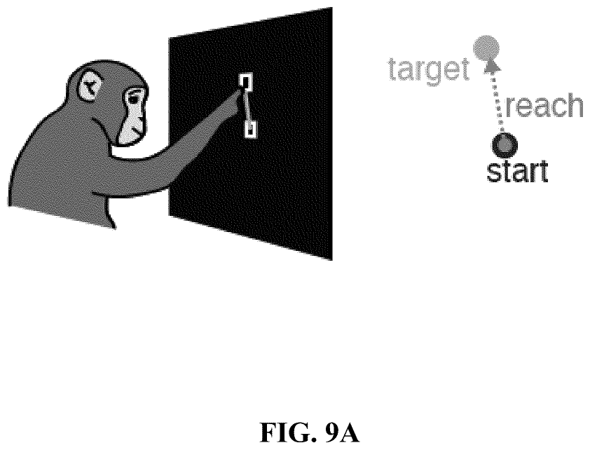

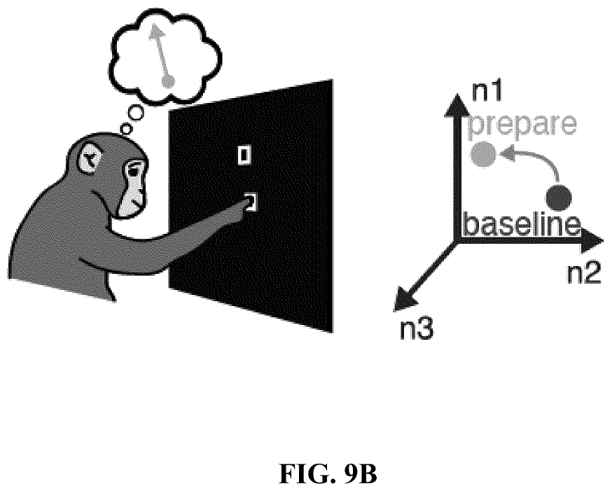

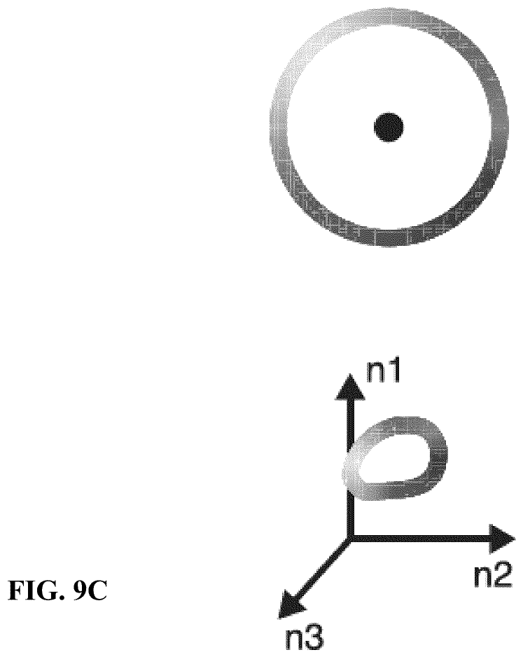

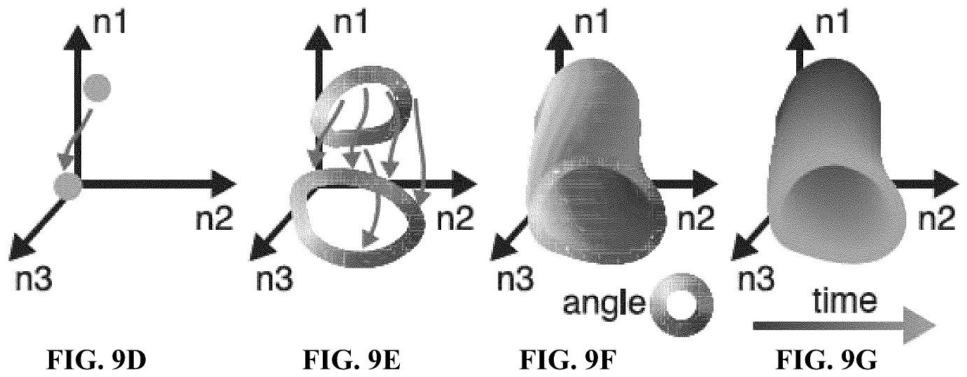

FIGS. 9A-F illustrate the smooth dynamics generating neural activity. FIG. 9A illustrates the example task of a monkey reaching from a central starting point to a presented target, where the targets are positioned on a ring.

To show dynamical systems theory can enable decoding from neural data, take as an example a monkey reaching to targets on a ring from some center point while neural activity is being recorded from the motor cortex (FIG. 9A). During movement preparation, the population state moves from a baseline population state to a point in the neural state space reflecting preparation for the reach (FIG. 9B). As motor cortex dynamics are smooth, reaches to similar targets will have a similar preparatory state in the neural state space. As such, if all possible states are considered during preparation across all targets, preparatory activity will form a ring in state space (FIG. 9C). The target angle will be encoded by the point that activity occupies along the ring shown in FIG. 9C.

During movement, dynamics will drive the population state to trace out a trajectory (FIG. 9D). Because trajectories caused by dynamics are smooth, the dynamics preserve the ring structure of the potential population states over time (the possible trajectories). This means that in different “moments” of the reach (e.g., movement start, 100 ms after movement start, etc.), the population states across targets will still form a ring, just in a different part of neural state space (FIG. 9E). This means that across targets and moments in the reach, population states lie on a tube in state space. Angle is encoded along the “angle” of the tube, while time in the reach is encoded along the axis of the tube (FIG. 9F). Dynamics cause the population state to only ever be moving “forward” on the tube.

In accordance with an aspect of the present disclosure, the intuition built by this example can be formalized. Just prior to movement, population states will lie on a low-dimensional manifold (a smooth but possibly curved surface, embedded in a higher-dimensional space). The shape of this manifold will reflect the “shape” of the set of allowed movements: reaching from a point to a ring of targets will have a ring-like manifold; reaching from a point to a line of targets will have a line-like manifold; more complex sets of movements will have more complex manifolds reflecting the structure of this complexity. From movement onset onwards, dynamics will drive population states forward, but moment-by-moment will preserve the shape of the preparatory population states. This will trace out a manifold, reflecting the movement structure with an additional dimension for time in movement. Note that although the manifold is intrinsically low-dimensional, it may curve and twist in complex ways through a high-dimensional space, like a novelty drinking straw.

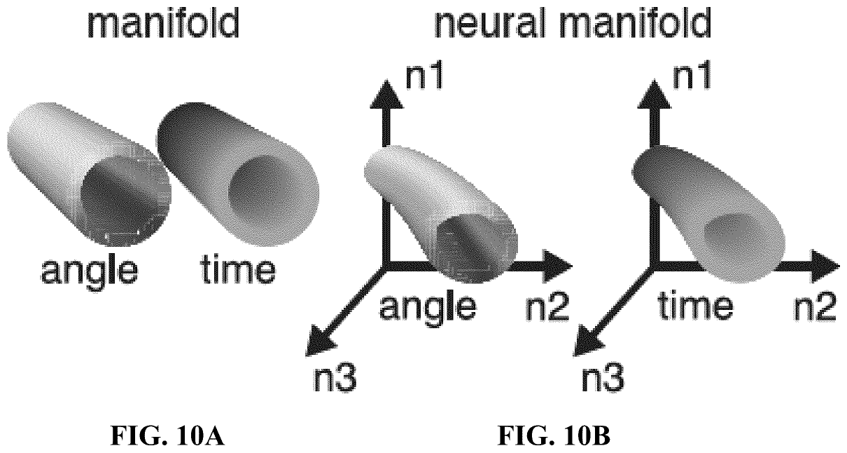

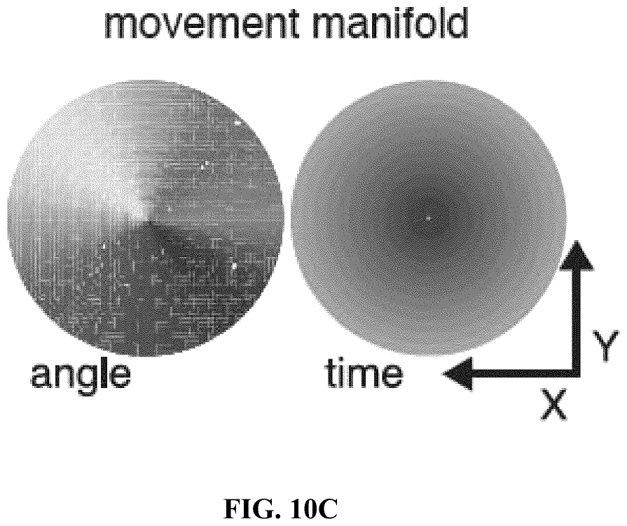

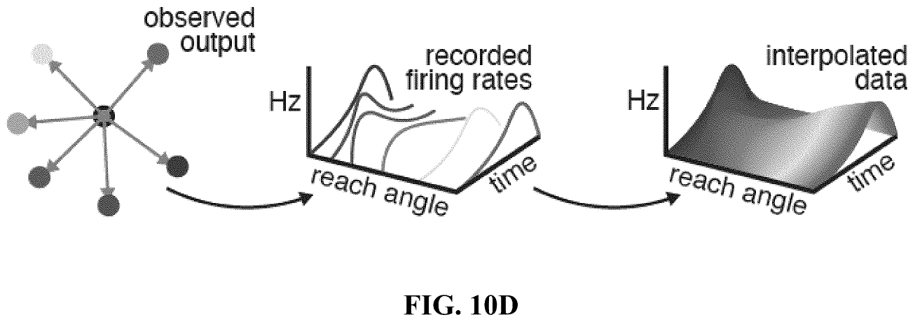

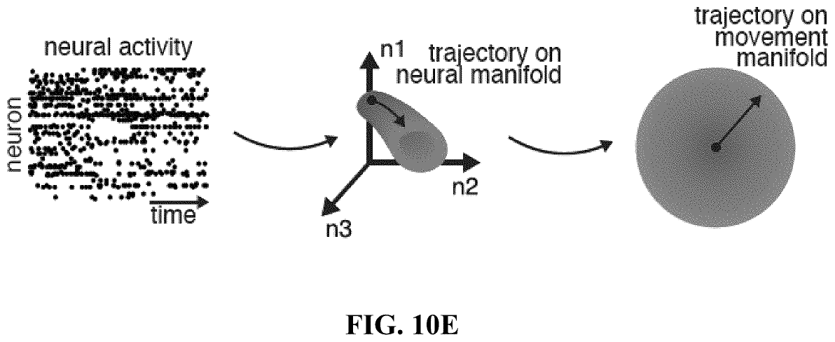

This structure, though, means that position on the manifold will conveniently encode movement type and time in movement. On this manifold, dynamics can be expressed as a flow forward along the time axis. These principles are used to formulate a new decoder, which uses manifold-discovery, dynamical systems theory, and Bayesian methods to decode outputs by inferring position on the neural manifold. The decoder can take data in pairs: neural recordings and desired outputs. In some instances, neural recordings can be electrophysiological recordings from many neurons, and the outputs can be the shapes of movements made by the subject. In other instances, these may be other kinds of recordings from a brain region along with movements presented or suggested to a human participant. Embodiments of the decoder treat both outputs and neural recordings as two “views” of the same underlying manifold, and uses interpolation to “fill in” across movement types and times in movement (FIGS. 10A-D). One of these views is in neural state space, and parameterizes function of movement type and time in movement (FIG. 10B). The other view is in the space of outputs (hand position, cursor speed, etc.) and parameterizes outputs as a function of movement type and time in movement (FIG. 10C). One computationally convenient way to estimate this manifold is to interpolate the states on a grid, to create a discrete approximation to the underlying manifold (FIG. 10D). Other manifold-parametrization processes can be used instead.

In order to decode, embodiments of the decoder infer position on the manifold from the activity of recorded neurons over time (FIG. 10E). As position on the manifold corresponds to outputs, this position is informative of the “correct” output at a moment in time. This estimation of position on the manifold is performed probabilistically. One way to incorporate both the previous estimate of manifold position and the new evidence from the neural recordings is to use Bayesian Recursive Estimation (BRE). BRE updates a probability distribution over positions on the manifold, combining prior probability distributions over position on the manifold with current neural activity to produce a more refined distribution over positions on the manifold. The decoded position on the manifold can be taken as the maximum likelihood estimate (the grid-point with the highest probability), and the corresponding values of command signals are outputted. This results in a time series of neural activity being decoded into a time series of command signals.

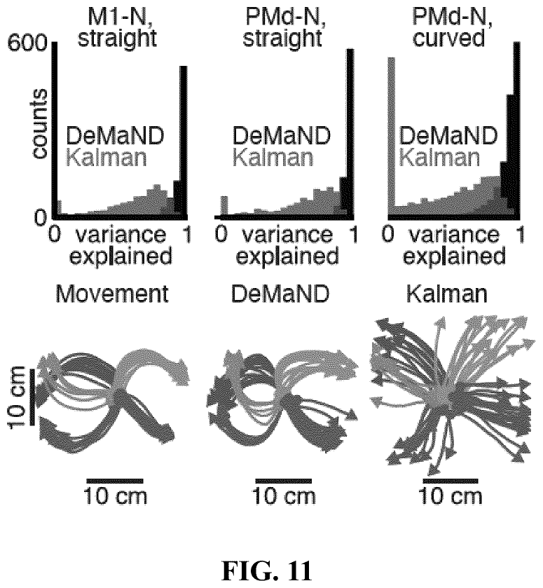

By using interpolation, embodiments of the disclosure are able to perform few-shot generalization from a small number of training examples to decode a large space of possible control signal values over time. By constraining the population state to a manifold, and learning dynamics on this manifold, the decoder is able to more accurately infer population state despite neural noise, and therefore produce more reasonable outputs over time. The decoder's ability to decode motor signals from spiking activity in motor areas was tested, specifically, the decoder's ability to decode arm movements from spiking activity in the motor cortex while monkeys performed straight and curved reaches was analyzed. Embodiments of the decoder were able to decode approximately 88-96% of the variance in hand position over time (FIG. 11A-B). This is significantly higher than the prediction quality used by current BMI decoders, which plateau at approximately ˜60% variance. As a proof of principle for BMI applications, the decoder's ability to decode observed movements from motor cortex spiking activity in a human participant with tetraplegia was tested. The decoder was able to decode approximately 85-91% of the variance in the observed hand position over time. This again is significantly higher than prediction quality provided by current BM decoders, which achieve approximately 50-60% variance.

FIGS. 11A-B illustrate the decoder precisely decoding movement from motor cortical data. In FIG. 11A, the decoder is shown decoding most of the variance in hand position during straight or curved reaching as opposed to the commonly used Kalman filter. In FIG. 11B, true hand trajectories using a decoder and a position/velocity Kalman filer.

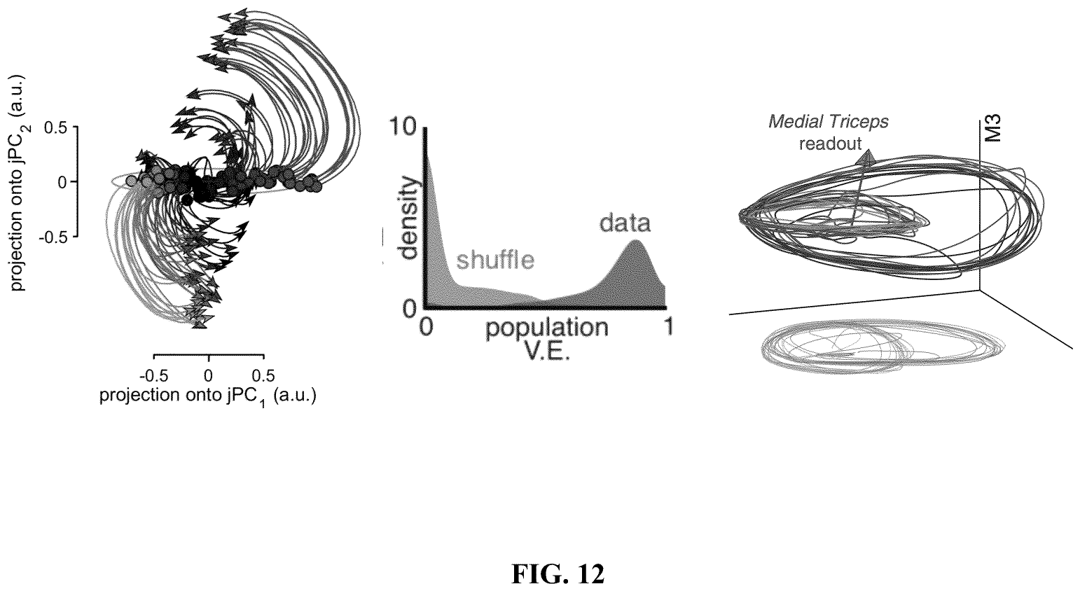

FIG. 12 is a series of graphs illustrating an exemplary neural input projection. Density as a function of population is included in the central graph, where gathered data is shown on the left hand side and an interpolated shuffle is on the right hand side. The final graph displays a readout of the medial triceps data movement over time. A neural population is recurrently driven during movement. The left side of FIG. 12 shows a jPCA plot of neural activity during reaching exhibiting “rotational” dynamics. The center graphs of the figure illustrate variance explained in motor cortex activity during reaching by a dynamical systems model (purple), along with distribution expected by chance (gray). The right side of FIG. 12 illustrates motor cortex activity during a cycling task. Motor cortex activity exhibits “rotational” dynamics, which are used as supporting activity to generate “muscle-like” commands.

### Parametrizing the Neural Manifold

Recent studies have observed that, during movement, motor areas of the brain appear to act as an autonomous dynamical system. In particular, heterogeneous firing rate modulation during movement at the single-neuron level appear to reflect population-level factors. These factors, while reflecting movement, appear optimized to prevent “tangling” so that trajectories in neural state space never cross. This has been used to argue that motor cortex neurons collectively act as a recurrent dynamical system, where:

$$\frac{d}{dt} r ( t ) = f ( r ( t ) )$$

where r(t)∈R^{N} is a vector of firing rates and f is a vector-valued, potentially nonlinear function defining the dynamics.

This framework has been used to explain preparatory pre-movement firing rate modulation in motor cortex. During movement preparation, single neurons experience substantial firing rate modulation. This modulation does not appear to be “sub-threshold” encoding of upcoming movements. Preparatory activity rather appears to reflect setting the population state to the appropriate location in neural state space, such that subsequent movement-epoch dynamics produce the correct trajectory. In the dynamical systems, from some initial population state r₀, the population state at time t is given by:

$$r ( t ) = r ( 0 ) + \int f ( r ( τ ) ) d τ .$$

Assuming r(0) represents the initial state of the neural population during the execution of some movement, neural activity traces out some trajectory in neural state space determined entirely by the initial state. In this sense, neural activity in this condition can be written as a function of t∈[0, T], where Tis the duration of the movement. Assuming r(0) does not lie within a limit cycle, movement progression is therefore naturally encoded along the trajectory.

Assuming the different trajectories are required for different movements i and j, different conditions will use different initial conditions rᵢ(0) and rⱼ(0). The dependence of neural activity at time t on the initial state can be formalized in a flow φ: R^{N}×R→R^{N}, so that:

$$ϕ ( r ( 0 ) , t ) = r ( 0 ) + \int f ( r ( τ ) ) d τ$$

Multiple studies have noted that neural states vary smoothly across conditions, so that similar conditions have similar initial states. This is formalized with a condition manifold, M, and a function g: M→R^{N}. The condition manifold M captures the structure and degrees-of-freedom of movement. Reaches from a point to a ring of targets, for example, necessitate M=S^{l}.

Similarly, reaches from a point to any other point in space necessitate M=R³. The function g maps from the condition manifold to initial states. It is assumed that g is continuous. Using g, we can parameterize the neural manifold using the modified flow, ψ: M×T→R^{N} so that:

$$ψ ( m , t ) = ϕ ( g ( m ) , τ )$$

where m∈M and t∈[0, T]. For simplicity, it is assumed all movement has duration T. Assuming f does not generate periodic orbits over the duration of movement, φ therefore parameterizes the neural manifold generated by dynamics in neural state space for a set of movements.

Alternatively, ψ can be interpreted as an injective embedding of the task manifold M×[0, T] into neural state space. This manifold can be equipped with intrinsic dynamics reflecting movement progression moving forward in time,

$$\frac{d τ}{dt} = 1$$

and conditions remain static:

$$\frac{dm}{dt} = 0$$

for m∈M and t∈[0, T]. Differentiating y with respect to t yields f, meaning the embedding reflects dynamics in neural state space. The neural manifold can therefore be parametrized solely in terms of movement coordination and progression.
Decoding from the Neural Manifold

As the neural manifold is naturally parameterized by movement condition and progression, instantaneous movement parameters such as velocity can be decoded naturally. The value of the movement parameters of interest at time can be expressed as a function of condition and progression, k: M×T→O where O is some space of movement parameters. Notably, k is a separate function on the task manifold. Position on the neural manifold, therefore, directly encodes for movement parameters. Let x∈R^{N} be a point on the neural manifold, x=ψ(m, τ) for some m∈M and t∈[0,T]. The associated movement parameters o are given by:

$$o = k ( {ψ}^{- 1} ( x ) ) .$$

where ψ⁻¹ maps from the neural manifold to the task manifold. This form of decoding works markedly differently than standard decoders. Rather than fitting and inverting an instantaneous encoding of movement parameters in neural activity, this decoding identifies the current progression through movement and movement condition using position on the neural manifold. This position only then secondarily informs outputs through a separate function on the task manifold. This makes it relatively trivial to switch decoded parameters by simply replacing the secondary function on the task manifold.

### Fitting the Neural Manifold and Outputs

While dynamics in neural state space necessitate that, for a set of movements, neural activity lies on a low-dimensional manifold, practical methods of identifying this manifold are required. In practice, neural activity is recorded on some finite sets of movements, in binned spike counts. Movement is similarly discretely recorded. This yields a set of conditions

$${\{ c ( i ) \}}_{i = 1}^{C} .$$

Each condition c(i) is a set of tuples

$${\{ ( r ( j ) , o ( i ) ) \}}_{j = 1}^{T}$$

of firing rates and movement parameters respectively across T time-points. For simplicity, equal duration is assumed among sampled movements. From {c(i)}, an estimate of the neural manifold, ψ and outputs k that are “close” to the neural manifold ¿ is extracted and movement parameters across all conditions and progressions.

To do so, a parameterization of M that converts C conditions from categorical identifiers to points in a continuous space is required. In some instances, this can be done by using a parameterization of the task: for example, identifying each condition in center-out reaching with the angle of the target, or appending to this parameterization further information about reach curvature and speed. In other instances, this parameterization will need to be learned. In some instances, this can be done in an auto-encoding framework. This takes the problem of finding some set of latent parameters

$${\{ θ ( i ) \}}_{i = 1}^{C}$$

and a function such that E(θ) approximates the movement parameters across conditions. These parameters and function may be learned using matrix-factorization methods, non-linear function approximation, or neural networks.

Once learned, the set {θ(i)} can be used for approximations of the task manifold. It is assumed that set resides in some estimate of the condition space, \tilde{M}. Rather than being associated with categorical condition indices 1, . . . , C and time indices 1, . . . , T, firing rates and movement parameters are treated as samples from \tilde{M}×[0, T]. Standard methods in function-learning can then be used to “fill in” between the samples. This involves fitting firing rate functions and movement outputs, ψ: \tilde{M}×[0, T]→R^{N} and \tilde{k}:\tilde{M}×[0, T]→O. In some instances, this can be performed with standard interpolation procedures. In other instances, these maps can be learned with non-linear function approximation or neural networks.

### The Principles of Real-Time Decoding

Having identified the task manifold, neural manifold, and movement output, a method of identifying position on the neural manifold in real time is required. This problem is challenging in general. Spiking patterns differ on different executions of the same movement. This has led to assertions of neural spiking as stochastic, at least with respect to behavior. Neural activity has been well-approximated as a time-varying Poisson process so that over some time bin δt, s(δt)˜Poisson(r(δt)), where r(δt) is a vector of mean spike counts over δt and s(δt) is a vector spike count with one entry per neuron. As sums of Poisson distributions remain Poisson distributions, this framework generalizes to multi-unit activity. In this framework, identical trials of the same movement largely have the same “firing rates”, but generate different spiking patterns due to Poisson variability.

As previously defined, the neural manifold is defined over firing rates. Spiking activity therefore only noisily reflects position on the neural manifold. Through the neural manifold, a condition m and progression interval (τ, τ+δt) have likelihoods of emitting spike-counts s(δt):

$$L ( m , τ , δ t , s ( δ t ) ) ∝ exp ( {\sum }_{n = 1}^{N} ( log ( {r}_{n} ( m , , τ , δ t ) ) {s}_{n} , s ( δ t ) - {r}_{n} ( m , , τ , δ t ) ) )$$

where rₙ is an element n of r and

$$r ( m , , τ , δ t ) = {\int }_{τ}^{τ + δ t} \frac{ψ ( m , r )}{l} dr$$

and l adjusts the firing rate linearly to the length of the time bin. While in principle this instantaneous likelihood could be used to decode position, spiking variability often renders instantaneous estimate of firing rate likelihood too unstable for MLE decoding. Firing rates, however, are not independent over time, but linked by dynamics. On the neural manifold, this takes the form of movement progression, τ, moving forward with time. This allows for Bayesian inference of position on the neural manifold over time. Let Pₜ(m, τ) be a probability distribution over the neural manifold at time t. During a time bin δt, spike counts s(δt) are observed. Due to dynamics, there is a prior probability distribution P′_{t+δt} over manifold positions given by P′_{t+δt}(m, τ)=Pₜ(m, τ−δt). This is combined with the likelihood of the observed spike counts to yield a posterior probability distribution:

$${P}_{t + δ t} ( m , τ ) ∝ L ( m , τ , δ t , s ( δ t ) ) {P}_{t + δ t}^{‵} ( m , τ ) .$$

This has the effect of integrating prior spike counts into the current estimate, in order to stabilize the estimated position.

This filtering produces a probability distribution over positions on the neural manifold, and by extension each position on the task manifold, for each point in time. This induces a probability distribution over movement parameters at each point in time, though as k is not necessarily an embedding this may not preserve local probability densities.

### Discrete DeMaND Decoder

While motivated in the continuous case, in practice the task manifold is often gridded finely. This produces a point cloud in neural state space that approximates the neural manifold. This simplifies several aspects of decoding. First, Bayesian updating is simplified, in particular for normalization of the posterior distribution and avoiding working in the space of distributions. Second, firing rates, log firing rates and movement parameters can be precomputed and stored for each grid point, allowing for faster online inference than would be allowed by online computation of firing rates in the continuous case. Finally, dynamics can be represented as a series of arrows “pointing” from one grid point to the next.

In this discrete formulation, the DeMaND decoder acts akin to a large, sparse Hidden Markov Model with Poisson emissions. Decoding can be correspondingly performed with Bayesian Recursive Estimation. Let p(t) be the probability distribution over grid points at t, with one element per grid point. Let T be a transition matrix, with T(i, j)=1 if grid-point i is one time bin ahead of grid-point j, and T(i, j)=0 otherwise. The posterior distribution, given spike counts s(t+1),

$$p ( t + 1 ) ∝ Tp ( t ) ∘ L ( s ( t + 1 ) )$$

where ∘ indicates the Hadamard product, and

$$L ( s ( t + 1 ) ) ∝ exp ( {\sum }_{n = 1}^{N} ( log ( \frac{r ( n )}{l} ) {s}_{n} ( t + 1 ) - r ( n ) / l )$$

where r(n) is a vector of firing rates for neuron n at each grid point.

In practice, itis additionally helpful to convolve the probability distribution after updating with a narrow Laplace distribution. At each time point, the movement parameters associated with the likeliest state can be output as the MLE estimate of output.

In practice, using Bayesian Recursive Estimation rapidly becomes expensive due to cost of updating growing linearly with grid points. In practice, probability distribution largely converges to a tight estimate of the state, meaning most of the update cost is spent on low-probability areas of the manifold. This issue can be ameliorated with a particle filter. Denote

$${\{ {p}_{i} ( t ) \}}_{i = 1}^{P}$$

the set of P particles at time t. Each particle is represented as a list of coordinates, pᵢ(t0=m₁, . . . , m_{|M|}, τ) where |M| indicates the number of coordinates. With each additional time bin, we increment the last coordinate forward one time bin to reflect movement progression. Additionally, to ensure particle diversity each particle's coordinates is randomly perturbed. Weights of the particles are then calculated:

$${w}_{i} ( t + 1 ) ∝ exp ( {\sum }_{n = 1}^{N} ( log ( \frac{{r}_{n} ( i )}{l} ) {s}_{n} ( t + 1 ) - r ( i ) / l )$$

where wᵢ(t+1) is the weights of particle pᵢ at time t+1 and rₙ(i) is the firing rate of neuron n at the grid point occupied by pᵢ. Weights are normalized to a probability distribution. Let o(i) be the movement parameters associated with the grid point occupied by particle pᵢ. The output where y(t+1) is then assigned as:

$$y ( t + 1 ) = {\sum }_{i = 1}^{P} {w}_{i} ( t + 1 ) o ( i ) .$$

Particles are then re-sampled with replacement, with the weights acting as a categorical distribution over particle probability. As quantities associated with grid points can be precomputed, computations focus on “likely” areas of the neural manifold, and dynamics can be efficiently represented by incrementing the progression coordinate of each particle, inference time can be made rapid with this approach.

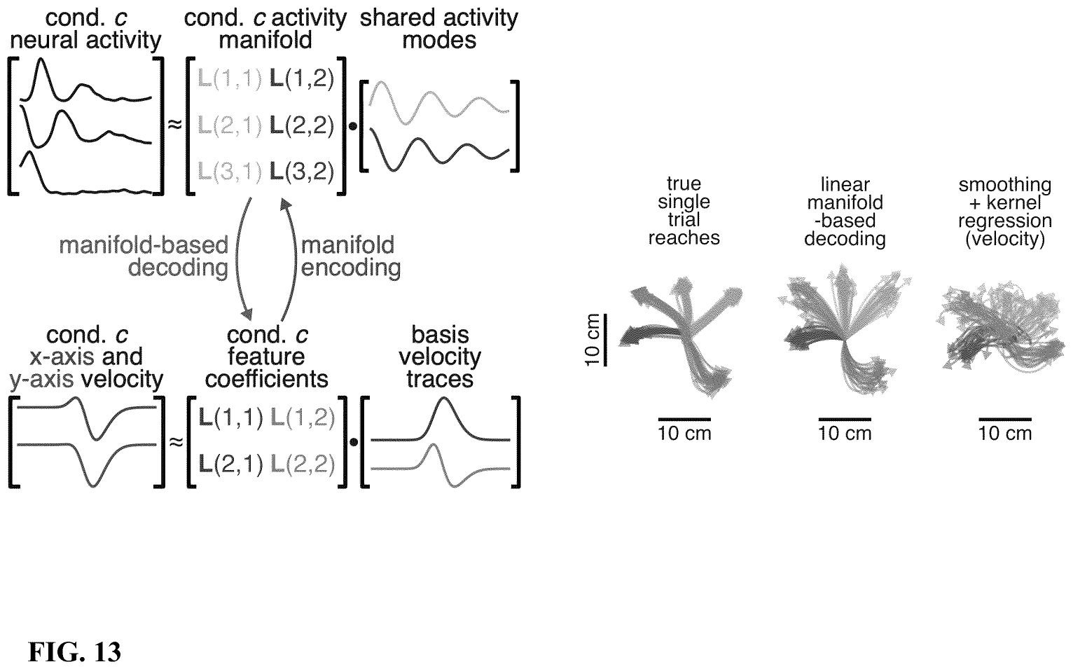

FIG. 13 is an exemplary illustration of a transformation, encoding, and decoding of a manifold. Trajectories in a neural state space linearly encode for kinematics. The left-hand side of FIG. 13 is an illustration of an encoding-decoding procedure. For each condition, a low-dimensional summary of neural activity over time or a “loading matrix” is extracted, alongside a description of reach kinematics over time or “feature coefficients”. Linear regression is used to map from feature coefficients to loading matrices, fitting an encoding-decoding model. On the right hand side, kinematics are inferred from loading matrices, which substantially outperforms other approaches, such as smoothing spiking data and then using kernel regression to instantaneously recover kinematics.

Embodiments of the disclosure as presented include a novel approach to decoding problems, GrID-MaPT, that enables high-quality and rapid decoding from systems with highly nonlinear dynamics and outputs, nonlinear relationships between latent and observed variables, and state-dependent noise. GrID-MaPT explicitly uses flowbox coordinates, a construction from dynamical systems theory, to construct a PT-manifold to represent the system's state space. In this PT-manifold, dynamics are simplified to incrementing system time for-ward. Using this construction imparts three advantages. First, dynamics are simplified to addition along a single dimension of the PT-manifold, which replaces potentially-expensive evaluations of a dynamics function. This simplification allows for rapid inference steps, enabling online decoding in some use cases. Secondarily, this representation allows for decoding without explicit access to the state. By basing the operation on a strong implicit link between patterns of outputs over time and the system's state, GrID-MaPT enables state inference and decoding without direct access to the system's state. This further allows for cheap and rapid interpolation of system outputs, replacing the need for more expensive inference methods such as neural networks. Finally, by explicitly inferring the system's state, GrID-MaPT can be rapidly repurposed to decode any possible output of the system. This may be substantially advantageous in control systems, where decoding of moment-by-moment outputs may be supplemented by decoding a high-level description of the system's state.

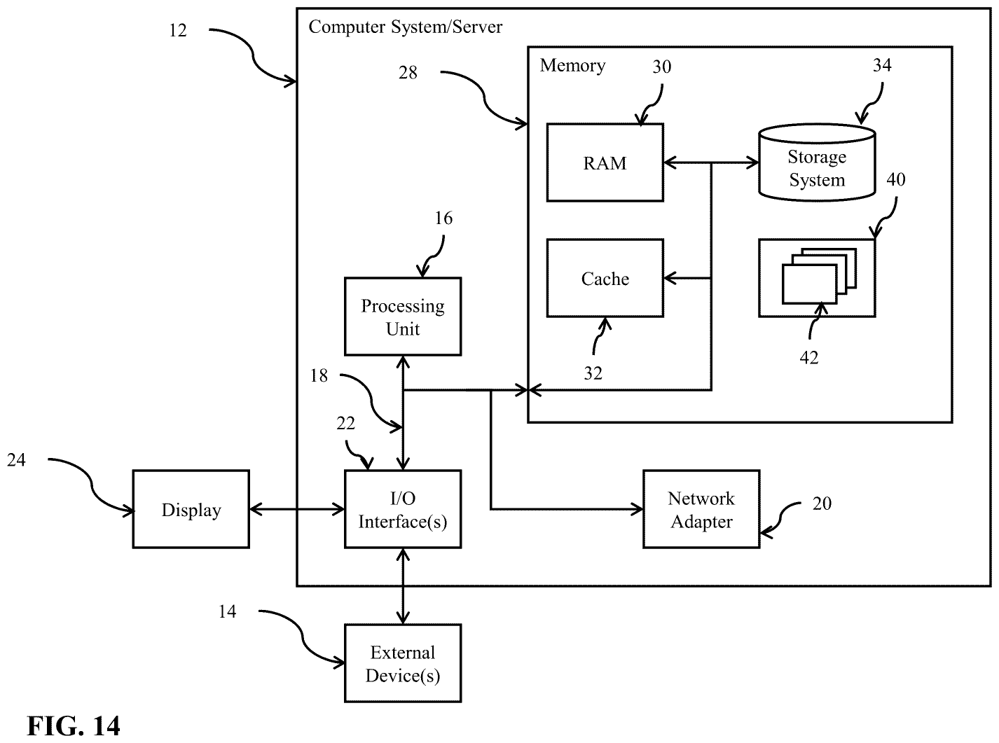

Referring now to FIG. 14, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 14, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method, comprising:
reading a collection of signals over a period of time;
interpolating the collection of signals to form a signal manifold;
constructing a gridded manifold in parameter state space, where one parameter is time;
inferring a state as a position on the gridded manifold based on the collection of signals;
propagating a probability distribution of the state over the gridded manifold; and
based on the probability distribution of the state, predicting one or more output.

2. The method of claim 1, wherein:
the collection of signals comprises neural signals; and
progression of the state corresponds to progress through a movement.

3. The method of claim 2, wherein the collection of signals is read from a brain-machine interface.

4. The method of claim 1, further comprising:
determining a time series of control signals for an effector based on the predicted one or more output.

5. The method of claim 4, further comprising receiving a desired output signal, associated with the collection of signals, as training data.

6. The method of claim 1, wherein the gridded manifold comprises a parametrized continuous set of signals over time.

7. The method of claim 6, wherein the signal manifold is parametrized in a space of possible neural population states.

8. The method of claim 1, wherein the inferred position is based on a collection of signals of neurons.

9. The method of claim 4, wherein controlling the effector comprises instructing a computer and/or a robot to move.

10. The method of claim 1, wherein propagating the probability distribution over time uses Bayesian Recursive Estimation.

11. The method of claim 4, wherein inferring comprises:
moving the probability distribution over the gridded manifold forward one step in time;
convolving an uncertainty estimation with the probability distribution;
assigning a likelihood of producing an observed spike count from an associated population state within the collection of signals to each grid point;
normalizing the likelihood with the previous probability distribution to determine a maximum likelihood estimation; and
outputting a stream of spike counts as a time series of control signals.

12. The method of claim 1, wherein inferring comprises:
moving the probability distribution over the gridded manifold forward one step in time;
convolving an uncertainty estimation with the probability distribution;
assigning a likelihood of producing observed signals from an associated population state to each grid point;
normalizing the likelihood with the previous probability distribution to determine a maximum likelihood estimation; and
producing a time series of output signals.

13. The method of claim 12, wherein the observed signals are neural signals, and the output signals are control signals for a BMI.

14. The method of claim 1, wherein the gridded manifold is a discrete approximation to the manifold.

15. The method of claim 1, wherein the collection of signals includes signals from brain and/or motor neurons.

16. The method of claim 1, wherein the gridded manifold has a circular time dimension.

17. The method of claim 1, wherein the collection of signals is read from a myograph and/or a brain computer interface.

18. The method of claim 2, wherein each point in the manifold is associated with a movement type and a relative time.

19. The method of claim 18, wherein the movement type includes a movement-related progression prior to the movement.

20. The method of claim 19, wherein the movement type includes a movement-related progression during the movement.

21. The method of claim 1, further comprising identifying one or more neural trajectories within the manifold.

22. The method of claim 21, wherein the one or more neural trajectories comprise a spiking pattern in neural signaling over a threshold value.

23. The method of claim 22, wherein the spiking pattern is independent of a movement.

24. The method of claim 21, wherein a starting state of one or more neural trajectories is determined by an initial state of a neural population.

25. The method of claim 1, wherein the collection of signals is collected from a subject during a set of movements.

26. The method of claim 1, further comprising pairing the manifold with an observed set of motions.

27. The method of claim 1, wherein the collection of signals is read from sensors on a robot.

28. The method of claim 1, wherein the collection of signals is read from medical testing data, such as an electrocardiogram or cardiac ultrasound.

29. The method of claim 1, wherein the collection of signals is read from sensors on an aircraft or spacecraft.

30. The method of claim 1, wherein the collection of signals is read from financial market data.

31. A system comprising:
an effector;
a computing node configured to perform a method comprising:
reading a collection of signals over a period of time;
interpolating the collection of signals to form a signal manifold;
constructing a gridded manifold in parameter state space, where one parameter is time;
inferring a state as a position on the gridded manifold based on the collection of signals;
propagating a probability distribution of the state over the gridded manifold; and
based on the probability distribution of the state, predicting one or more output; and
providing a time series of control signals to the effector based on the predicted one or more output.

32. A computer program product comprising a non-transitory computer readable storage medium having program instructions embodied therewith, the program instructions executable by a processor to cause the processor to perform a method comprising:
reading a collection of signals over a period of time;
interpolating the collection of signals to form a signal manifold;
constructing a gridded manifold in parameter state space, where one parameter is time;
inferring a state as a position on the gridded manifold based on the collection of signals;
propagating a probability distribution of the state over the gridded manifold; and
based on the probability distribution of the state, predicting one or more output.
